(19) United States
(12) Patent Application Publication
(10) Pub. No.: US 2016/0356666 A1
(43) Pub. Date: Dec. 8, 2016

(54) INTELLIGENT LEAKAGE DETECTION SYSTEM FOR PIPELINES

(71) Applicant: UMM AL-QURA UNIVERSITY, Makkah (SA)

(72) Inventors: Mohsin BILAL, Makkah (SA); Emad FELEMBAN, Makkah (SA); Adil Amjad Ashraf SHEIKH, Makkah (SA); Saad Bin QAISAR, Islamabad (PK)

(73) Assignee: UMM AL-QURA UNIVERSITY, Makkah (SA)

(21) Appl. No.: 14/728,834

(22) Filed: Jun. 2, 2015

(51) Int. Cl. G01M 3/28

(52) U.S. Cl. CPC G01M 3/2807

(57) ABSTRACT

A pipeline system and method include a sensor node having one or more sensors configured to measure sensory information collected from fluid flowing through a fluid transportation infrastructure. The sensor node also includes a processor configured to remove noise and unnecessary data from the collected sensory information and to extract statistical attributes associated with a leakage within the fluid transportation infrastructure. The sensor node also includes a trained classifier configured to test real-time sensor data received from the one or more sensors and processed by the processor. The sensor node also includes a transmitter configured to forward classified data from the trained classifier to a sink node within the fluid transportation infrastructure.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Pipelines are a widely used source for transportation of oil and gas worldwide. However, incidents of oil and gas pipeline failures are becoming rather frequent, causing large financial costs, environmental damages, and health risks. One cause of the incidents is due to a lack of accurate methods of inspection for oil and gas pipelines. Techniques and systems have been developed to monitor underground and above-ground pipelines. However, most of the systems are localized to a limited area and function as a single localized unit. Therefore, a total length of monitored pipeline may be less than a total length of unmonitored pipeline. In addition, the techniques can also be applied to a localized area and the data is not sufficient to ensure a safety and maintenance of underground and above-ground pipelines. Also, individual nodular data is frequently separated and evaluated by human-monitored platforms.

A negative pressure wave (NPW) technique can be employed for a leakage detection. However, an NPW method entails a complex analysis of pressure signatures under high noise scenarios and in the presence of slow leaks.

Wireless sensor networks (WSNs) can be used to detect a possible pipeline leak. In a centralized approach of utilizing WSNs, all sensor nodes transmit to a base station. This requires a high energy consumption and communication overhead, which results in a decrease in lifetime of WSN and a delay in transmission. Another approach can process the data on each sensor node and report the results to the base station for evaluation. This approach has a disadvantage of making an initial decision by a single node.

### SUMMARY

In one embodiment, a sensor node leakage detection system includes circuitry configured to preprocess fluid flow data from leakage signals and non-leakage signals of a fluid transportation infrastructure. The circuitry is further configured to extract leakage-related features from the preprocessed fluid flow data, and select higher-ranking subset features from the extracted leakage-related features associated with leakage detection in the fluid transportation infrastructure. The circuitry is further configured to reduce a number of the selected higher-ranking subset features to fit a classification model, and train one or more classifiers using the reduced number of selected higher-ranking subset features in a supervised learning module. The circuitry is further configured to determine a final learned classifier with a maximum generalization capability from the trained one or more classifiers, and run real-time fluid flow data from the fluid transportation infrastructure. The circuitry is further configured to identify leakage signals from the running real-time fluid flow data using the final learned classifier.

In one embodiment, a sensor node includes one or more sensors configured to measure sensory information collected from fluid flowing through a fluid transportation infrastructure. The sensor node also includes a processor configured to remove noise and unnecessary data from the collected sensory information and to extract statistical attributes associated with a leakage within the fluid transportation infrastructure. The sensor node also includes a trained classifier configured to test real-time sensor data received from the one or more sensors and processed by the processor. The sensor node also includes a transmitter configured to forward classified data from the trained classifier to a sink node within the fluid transportation infrastructure.

In one embodiment, a leakage detection system includes a plurality of sensor nodes positioned along a length of a fluid transportation infrastructure. Each of the plurality of sensor nodes includes circuitry configured to measure sensory information collected from fluid flowing through the fluid transportation infrastructure, remove noise and unnecessary data from the collected sensory information and to extract statistical attributes associated with a potential leakage within the fluid transportation infrastructure, and classify the collected sensory information associated with the potential leakage. The leakage detection system also includes one or more sink nodes positioned and interfaced with an associated subset of the plurality of sensor nodes. Each of the one or more sink nodes includes circuitry configured to receive and analyze the classified collected sensory information from the associated subset of the plurality of sensor nodes, ascertain whether the potential leakage is a true leakage, determine a size and location of the true leakage, and transmit results of the determining to a central governing body of the fluid transportation infrastructure.

The foregoing paragraphs have been provided by way of general introduction, and are not intended to limit the scope of the following claims. The described embodiments will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary algorithm used to obtain a learned classifier according to an embodiment;

FIG. 2A is a block diagram of an exemplary sensor node according to an embodiment;

FIG. 2B illustrates an exemplary leakage detection network according to an embodiment;

FIG. 3A is a block diagram of an exemplary sink node according to an embodiment;

FIG. 3B illustrates an exemplary initialization algorithm according to an embodiment;

FIG. 4 illustrates an exemplary underground pipeline monitoring system according to an embodiment;

FIG. 5 illustrates an exemplary above ground pipeline monitoring system according to an embodiment;

FIG. 6 illustrates an exemplary interconnection network of a WSN according to an embodiment;

FIG. 7 illustrates an exemplary local base station layout at a tier-2 level according to an embodiment;

FIG. 8 illustrates an exemplary flowchart for tier-1, tier-2, and tier-3 communication according to an embodiment;

FIG. 9 is a block diagram illustrating an exemplary electronic device according to an embodiment;

FIG. 10 is a block diagram illustrating an exemplary computing device according to an embodiment;

FIG. 11 is a block diagram illustrating an exemplary chipset according to an embodiment;

FIG. 12 is a block diagram illustrating an exemplary CPU of a chipset according to an embodiment; and

FIG. 13 illustrates an exemplary cloud computing system according to an embodiment.

### DETAILED DESCRIPTION OF THE EMBODIMENTS

Embodiments herein describe a network of autonomous wireless sensor nodes that are designed and configured to detect fluid leakage in its proximity within a fluid pipeline transportation infrastructure. Multiple sensory nodes are placed along the pipeline infrastructure, which communicate with one or more remote sink nodes. The embodiments can be used for an above-ground pipeline transportation infrastructure or a buried pipeline transportation infrastructure, wherein a buried pipeline infrastructure can be located below the ground surface, below a water surface, or within a deep or buried enclosure below a surrounding ground level. The pipeline transportation infrastructure can be designed and configured to carry water, oil, gas, or other liquid material across a spanned distance.

Centralized monitoring of water, oil, and gas pipeline installation and maintenance is difficult due to the length of the pipeline infrastructure, and can also be difficult due to rough terrains and intense environmental conditions. A self-sustainable and fully automated monitoring system that is designed and configured to detect leakages and inform a central controlling entity about the locality and degree of an anomaly is desired.

A WSN used in embodiments described herein includes inter-node communication, networking, and analysis of logged sensory data. Nodes are designed and configured to convert measured metrics from their associated sensors into digital information to be read and processed by a remote monitoring facility. Hardware resources include a processing unit, a sensing unit, a power manager, and a transceiver device. The sensing unit is directly connected to an analog-to-digital converter (ADC) to provide direct data conversion from a sensor sub-unit. The sensors can be placed over a large geographical monitoring area, which can entail communicating and networking with hundreds of nodes. Collection of data from each of the sensors is used for analysis and detection. A WSN considers factors such as sensor layout, data transmission methods, sensor node power requirements, data processing, analysis and inference points, operational design and framework of nodes, as well as network topology, infrastructure, and sensing-related technologies.

Embodiments described herein reduce communication overhead by processing raw data on sensor nodes directly and reporting the detected events only. An intelligent machine learning based algorithm can provide considerable accuracy for detection of slow and small leakages in natural gas and oil pipeline monitoring WSNs. Methods of support vector machine (SVM) uses optimal kernel function parameters and Gaussian mixture model (GMM) in multi-dimensional feature space.

A system for distributed leakage detection using WSNs allows various low power sensor nodes to cooperate to identify leakage in long range pipelines and estimate the leakage size. Overall communication costs are reduced because only the information pertaining to leakage status is exchanged between the nodes. The overall approach is to accommodate a pattern recognition algorithm to WSNs and train the sensor network to detect and classify new sets of events. The pattern recognition algorithm includes feature vectors from the raw data from local sensor nodes. This saves energy of local processing with a distributed evaluation to achieve high accuracy. The system can be used for numerous applications because pattern recognition algorithms are independent of the characteristics of the deployment area and there is an open choice for the type of sensors used.

Embodiments herein describe a system architecture for a one-dimensional (1-D) sensor network, where the sensor nodes are uniformly distributed over the pipeline, depending upon the communication range. A detection algorithm can be divided into three tasks, which include 1) sensor data acquisition, 2) noise removal, and 3) leakage event detection. For a number of nodes in a network, the majority of nodes can be designated as end nodes, while the remaining nodes function as cluster head nodes. A multiple-tier hierarchical strategy includes adjacent sensors grouped to form node communities. The nodes at the lower tier transmit information to higher-tier nodes. Data can be transmitted over a number of cluster nodes, depending upon the size of the network, until a fusion center is reached. Data aggregated at this level is sent for inference to a base station, where alarms can be generated for warnings.

Error debugging and fault tolerance grows with an increase in the number of nodes and when the number of data packets being transferred increases. Leakage event detection evaluates the condition of local and global elements within the communities. A distributed leakage detection algorithm determines the presence of a leak and its location, using the three stages in single-node processing and multi-node collaboration.

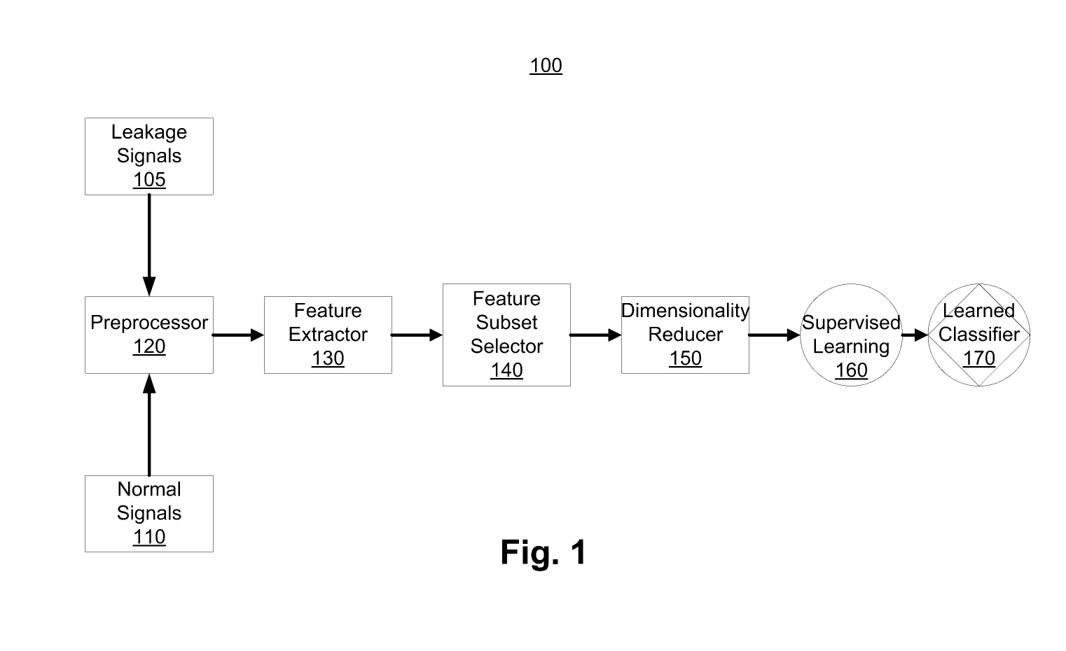

An intelligent mechanism is employed at each node to detect anomalies within the pipeline within its jurisdiction. A learned classifier is obtained and installed on each node. FIG. 1 illustrates an algorithm 100 by which a learned classifier can be obtained for leakage detection. Known examples of leakage signals 105 and normal signals 110 from pipeline sensors are obtained via a pre-processor 120 for noise rectification. After removing the determined noise features, features in a time and transformation domain are extracted from the signals via a feature extractor 130. A feature subset selector 140 selects a subset of features that are determined to improve detection accuracy. A dimensionality reducer 150 projects the subset features into least possible features to ensure the simplest classification model with a high level of accuracy. Different classifiers are trained and observed in supervised learning 160 to determine the classifier with the greatest generalization capability to achieve a final learned classifier 170.

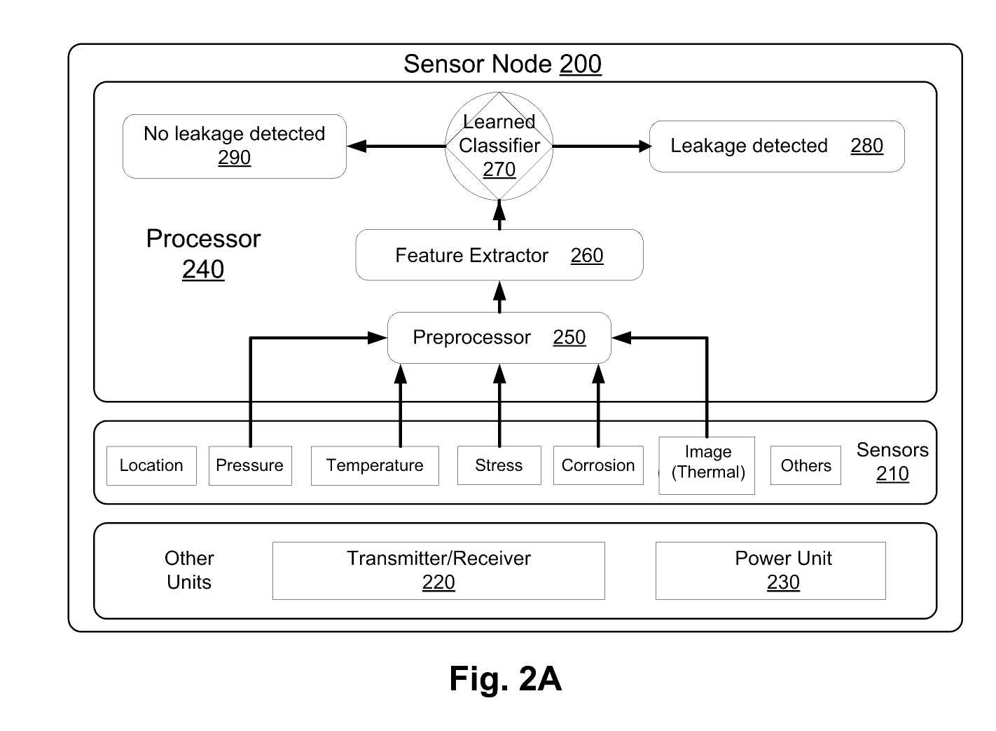

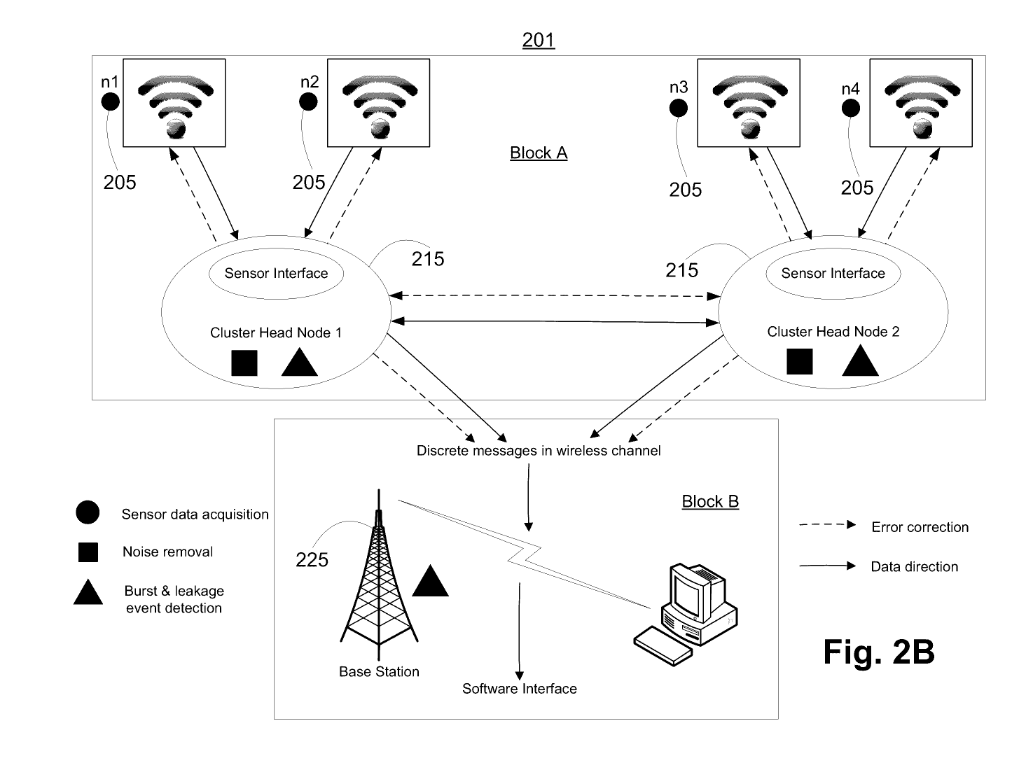

Each sensor node of a first tier is designed and configured to collect ambient data, process and analyze the data for a suspected leak, and transmit the data to a sink node. FIG. 2A illustrates a layout of an exemplary sensor node 200. Sensor node 200 can have a plurality of sensors 210 including, but not limited to a location sensor, a pressure sensor, a temperature sensor, a stress sensor, a corrosion sensor, and a thermal imaging sensor. However, other sensors 210 are contemplated by embodiments described herein, and could depend upon factors such as the type of fluid being transported, the size of the pipeline transportation infrastructure, the geographic area, natural and manmade environmental factors, natural and manmade risk factors, etc. Other units in the sensor node 200 include a transmitter/receiver 220 and a power unit 230. However, other units are contemplated by embodiments described herein and could depend upon factors, such as the factors described above.

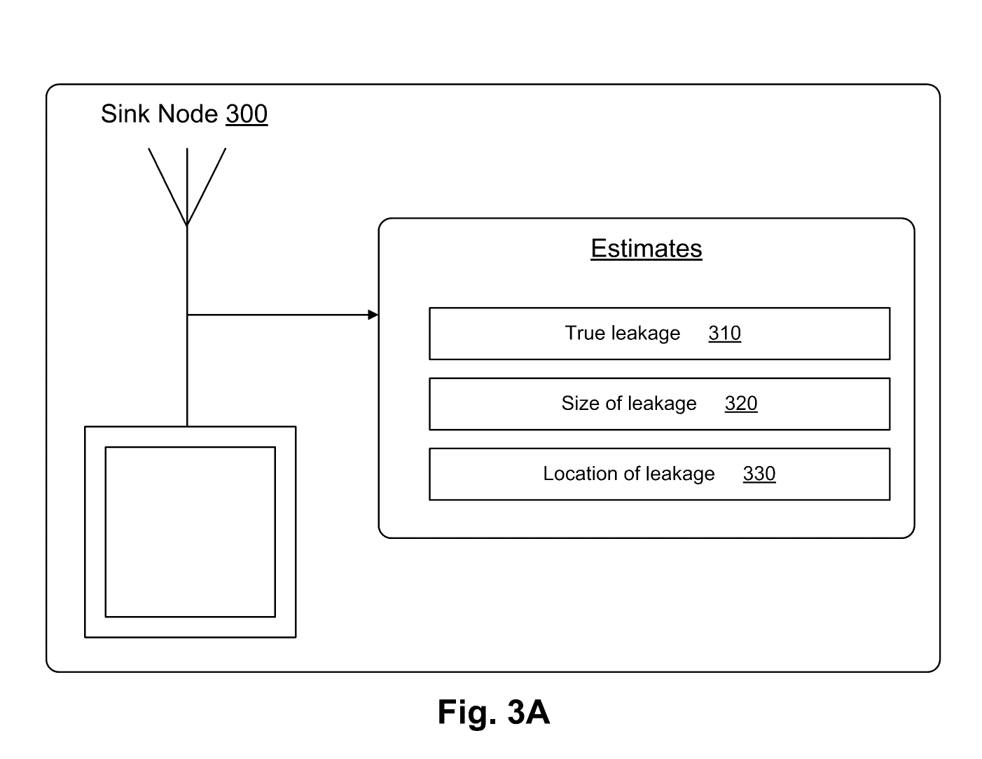

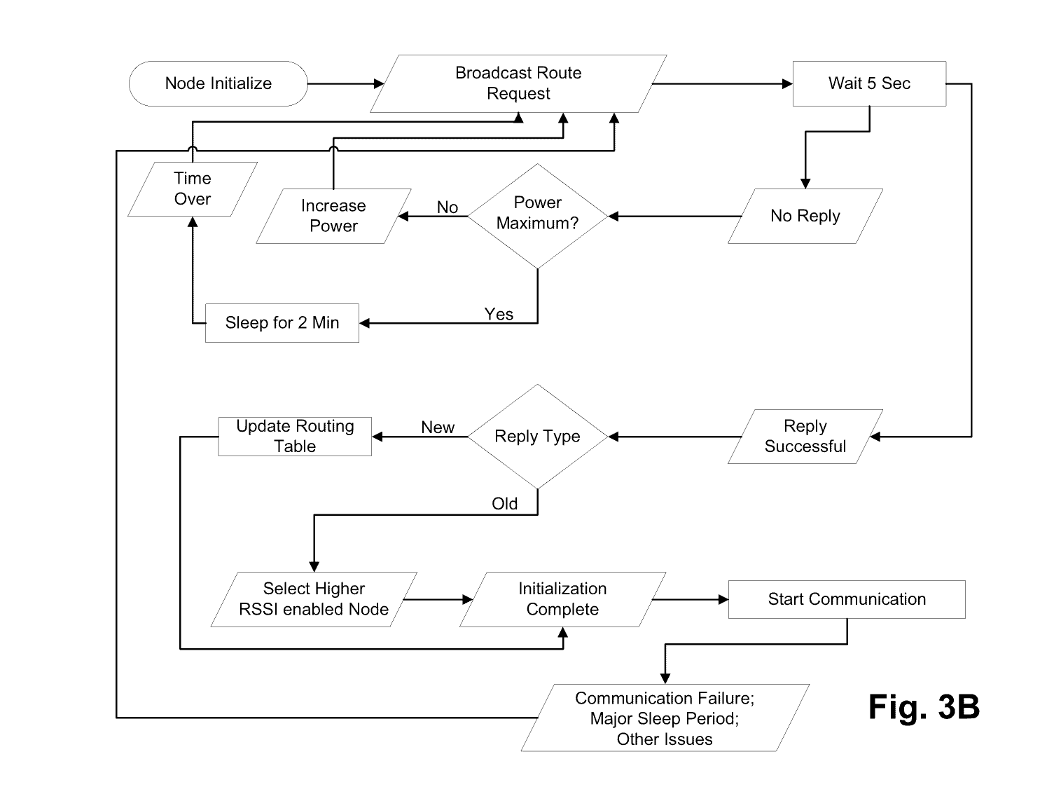

A processor 240 processes the data obtained from the sensors 210. The processor 240 includes a preprocessor 250 designed and configured to separate known leakage signals from other incoming signals, i.e. noise. A feature extractor 260 extracts a minimum number of features that will be required by the classifier. The minimum number of extracted features is forwarded in order to keep the processing as simple as possible. The extracted features are forwarded to a learned classifier 270, which was previously trained under a supervisory learning process and installed on the processor 240. Each new instance of processed data is tested on the classifier and labeled according to an analysis of the new processed data. If the analysis concludes a leak is present, the labeled data is forwarded to a leakage detector 280 for further processing. The further processing could include forwarding the data and analysis to an associated sink node. The sink node can be further designed and configured to generate an alarm if a true leak appears to be present in the pipeline. In addition, the sink node can estimate the size and location of the leak by analyzing information of neighboring nodes within the pipeline transportation infrastructure. If the analysis concludes a leak is not present, the labeled data is forwarded to a non-leakage detection module 290 for further processing, and is also forwarded to the associated sink node. A sink node will be discussed in more detail hereunder with reference to FIG. 3.

Leakages and bursts introduce a transition in pressure waves travelling along a fluid inside the pipeline, which is absent in an intact system. These transients travel along the length of the pipeline. A leakage point generates two transient waves, equal in magnitude but in opposite directions. Due to high pressure in the fluids, the leakage causes some attenuation in the transient signal, and thereby causes a negative pressure wave (NPW).

Embodiments for a pipeline monitoring system use signal processing and machine learning techniques to detect the presence of leakage in the pipelines. Sensor nodes acquire NPW data from the pipeline network. Pre-processing is performed to remove noise and unnecessary data to provide noise-free data. Noise signals can be removed using a low-pass filter and Daubechies wavelet transform. Extraction of statistical features from this data provides a basis to build candidate feature sets. A number of tests are performed on these candidate feature sets to qualify for a reduced feature set. This step is performed to avoid unnecessary computations of algorithm and to separate only discriminant features in space. Once the reduced feature set is formulated, a Gaussian mixture model (GMM) and Support Vector Machine (SVM) classifiers are trained on resulting feature vectors, along with targeted labels of class. The classifiers are used to detect the status of failure in pipelines. A more detailed description of signal processing and machine learning techniques used to detect the presence of leakage in pipelines is given hereunder.

A first aspect of a machine learning process is pattern classification in which a trace is assigned a particular class based on features of the trace. Binary classification can be used in which the pressure signal is classified into one of two classes. A first class includes non-leak or benign objects, which shows the fluid flow in the pipeline is normal and there is no defect present in the pipeline. A second class is a leak or non-benign object, which indicates the presence of a fault, deformation, or crack in the pipeline. In classification problems, learning is a process in which a system improves performance by experience.

A second aspect of a machine learning process is preparation of features for classification. The features are statistical quantities calculated from data that is to be classified. A feature is selected from objects of a same class of features clustered together in a feature space. A classifier can define the feature space of a particular class and assign data to the particular class within the feature space. The classification can be seen as a mapping process, where each input data point is classified to one of the first or second classes described above for a benign object or a non-benign object, respectively.

Pre-processing is performed to remove noise signals and to recover original signals in an attempt to identify pipeline leaks. Features or groups of features can be extracted from the recovered original signals to detect leakage in a pipeline. One of the groups of features to be extracted is various time domain features. A first time domain feature is an expected value, which is used to refer to a central tendency of probability distribution. In the case of a discrete probability distribution, it is computed by taking a product of possible values of random variable and corresponding probability, and adding these products together, giving an average value.

A second time domain feature is variance, which is the dispersion from the expected value for a set of numbers. A small value of the variance suggests the numbers in the set tend to be very close to the expected value, whereas a zero variance refers to identical numbers.

A third time domain feature is gradient, which points in the direction of the greatest increase of the rate of change of the function. Its magnitude is the slope in the direction.

A fourth time domain feature is Kurtosis, which defines the “peakedness” of the probability distribution of a feature vector. The normal distribution has kurtosis=3. If the value of kurtosis is greater than 3, the probability distribution is more outlier-prone, and if less than 3, it is less outlier-prone.

Another group of features to consider in extracting leakage detection information is spectral features. A first spectral feature is a pseudo spectrum, which uses the Eigen vector approach for estimation of pseudo-spectrum of particular signals, whereas the spectrogram is the short term Fourier transform.

A second spectral feature is power spectral density (PSD), which computes the average power of the signal. It is different from mean-squared spectrum because the peaks in this spectra do not reflect the power of a given frequency.

A third spectral feature is percentage of energy, which corresponds to a wavelet decomposed signal. It uses its vertical, horizontal, and diagonal details accordingly.

A fourth spectral feature is entropy, which measures uncertainty and unpredictability in the information content. Shannon entropy is one form of entropy which can be used.

Feature extraction and selection are major issues in machine learning. Candidate features include statistical attributes of data to be classified. The number of candidate features can be too large to reasonably manage. To improve the performance for classification, a subset of features in space can be selected, such that a number of the subset of features is much smaller than the number of the candidate features. This is referred to as feature reduction or dimensionality reduction.

Distributed leakage and burst detection includes single-node processing and multi-node collaboration for detection of an event. FIG. 2B illustrates a network 201 of different tasks between nodes for detection of an event. Block A illustrates a data collection and local inference module, whereas Block B illustrates a global inference module. Four end nodes 205 are illustrated, along with two cluster head nodes 215. In an embodiment, a Waspmote can be used as a sensor node in network 201. However, other sensor nodes and numbers of nodes can be used in embodiments described herein. Each sensor node 205 and 215 has a number of sensors, such as the sensors 210 illustrated in FIG. 2A. To check the validity of a sensor reading, the data can be cross-checked in a predefined dictionary to separate out the useless data. Readings from a location GPS and the battery status of the node can also be checked. The data acquisition is performed by nodes 205.

For local trending at each sensor node 205, the temporal pattern of pressure measurements is captured. A leakage and burst detection algorithm utilizes collaboration from neighboring sensor nodes 205 to reach a consensus for the presence of a leak. The local decision of the sensor nodes 205 is matched with a number of neighboring nodes 205 in the network 201. To identify a leak in the pipeline, behavior of the sensor data is analyzed and a decision of the cluster head node 215 is sent to a base station 225 after consensus, where wavelet transform and a NPW algorithm are performed.

Noise is usually present in pipeline flow. In order to clean the raw data of noise, a moving average filter can be used to eliminate noise sparks. This reduces the likelihood of a false alarm of an event detection. The cluster head nodes 215 perform noise removal and a leakage/burst detection algorithm. The decision of performing noise removal on the cluster head nodes 215 is taken to reduce the time required for the transmission of noisy data to the base station 225 level.

Monitoring a fluid pipeline requires sensing minute changes in the fluid transfer and pipeline orientation, as well as reliably reporting events to a remote central station in a minimum amount of time. An example of a sensor will be given for illustrative purposes only.

A sensor can include one or more modules for communication, such as a ZigBee module connected to a standard ten pin UART connector. A touchscreen LCD interface can be provided for user interaction with a software board set to tunable parameters. A precision accelerometer can be placed on the software board to allow for pipeline orientation monitoring. The wireless sensor board can be designed to prolong the software board's runtime by minimizing any current leakage sources in the circuitry. The software board can be designed to work in industrial temperature ranges, such as −40 to 85 degrees Celsius. The wireless sensor board can be designed around a microcontroller, in which several integrated circuits (ICs) and interfaces are connected through different protocols.

The microcontroller can be a 32-bit microcontroller based on RISC core operating at a frequency of up to 160 MHz. The microcontroller incorporates high-speed embedded memories and an extensive range of enhanced input/outputs and peripherals. A comprehensive set of power-saving modes, including the sleep and hibernate modes for a transceiver allow the implementation of a low-power monitoring application.

Interfaced application-specific sensors, including a digital pressure and temperature sensor of the pipeline fluid can be used. The sensor power requirements can be kept at 5 V and 25 mA maximum. The sensors can communicate using RS-485, RS-23 or SPI interfaces.

A ZigBee protocol-based module can be used for wireless communication. The communication module for the transceiver can have a standard ten-pin interface. A ZigBee standard compliant transceiver can provide an outdoor range of 3200 meters, indoor range of 90 meters, a transmit power of +18 dBm, and a receiver sensitivity of −102 dBm.

A rechargeable battery can be used to provide power to the wireless sensor board. A 2-cell 7.4 V lithium polymer battery pack can be used with a high capacity of 13,500 mAh.

When a leak takes place, pressure inside and outside the pipeline is different, which results in a NPW propagating at a particular velocity. The location of the leak can be predicted if the time delay between the NPW and the normal pressure waves inside the pipeline is known. The location of the leak can be found by using the following equation.

X=[L+v(Δt)]/2

where X=the distance between the leakage point and a pressure transducer, L=the distances between two pressure transducers, v=the negative pressure wave propagating velocity in a liquid medium piping system, and Δt=the time difference of the pressure wave getting to both pressure transducers on the pipeline.

Wavelet transform has an advantage in the analysis and processing of nonstable and nonlinear signals. NPW signals are nonstable and nonlinear, which can be decomposed in different frequency bands with different resolutions. As a result, eigenvector of the signals can be extracted. In the leakage detection and localization system, wavelet transform is applied to distinguish different sources that can cause a pressure drop. The hydraulic transient puts the system through a succession of different states or events. Wavelet transform can be used to extract the information of instantaneous change in the pressure signal. Once these characteristic points are known, leakage presence can be predicted to an acceptable level.

System noise can complicate the analysis of a leakage signal. In an attempt to overcome this problem, short time Fourier transform can be used, due to its narrowband and wideband transform nature. Multiresolution analysis can provide both good time resolution and frequency resolution. Noise removal requires multiresolution analysis of local frequency contents. Wavelet analysis can be applied to realize the advantages of analysis in both the frequency and time domains and to improve the effectiveness of the methodology.

Wavelet analysis removes signal noise and provides insight into the frequency content of the signal. A data object can be transformed into the wavelet domain. Some coefficients are selected and zero-filled or shrunk/truncated by a criterion. At the end, the shrunken or processed coefficients are inversely transformed to the original domain, which is the de-noised data. The pressure data signal of NPW is transformed to wavelets, and wavelet compression and de-noising are performed, followed by the event detection algorithm.

De-noising is the signal recovery from noisy data. The de-noising objective is to suppress the noise part of the signal and to recover the original signal. The steps for using wavelets include a wavelet transform, truncation of coefficients, and an inverse transform. In the de-noising process, a wavelet is chosen at a particular level. The wavelet decomposition of the signal is computed at that level. For each level, a threshold is selected and soft thresholding is applied to the detail coefficients. The wavelet reconstruction base is reconstructed on the original approximation coefficients at the particular level.

A wavelet function is a small oscillatory wave which contains both the analysis and the window function. Discrete wavelet transform uses filter banks for the analysis and synthesis of a signal. The filter banks contain wavelet filters and extract the frequency content of the signal in various sub-bands. The pressure signal is de-noised using wavelet packet transform. Wavelet compression is based on the concept that a regular signal component can be approximated using a small number of approximation coefficients and some detail coefficients.

A wavelet packet method is a generalization of wavelet decomposition that offers a vast multiresolution analysis. The wavelet packets can be used for numerous expansions of a given signal. The most suitable decomposition of the signal can be selected with respect to entropy. A single decomposition using wavelet packets generates a large number of bases. The generic step splits the approximation coefficients into two parts. After splitting, a vector of approximation coefficients and a vector of detail coefficients can be obtained, both at a coarser scale. The information lost between two successive approximations is captured in detail coefficients. The new approximation coefficient vector can be split. Each detail coefficient vector is also decomposed into two parts using the same approach as in approximation vector splitting.

The choice of decomposition levels of wavelets depends upon the signal to noise ratio. Single level wavelet decomposition is usually sufficient for less corrupted signals, whereas signals corrupted with higher noise densities may require a second level of wavelet decomposition. Wavelet transform helps to indicate the presence of a leak by providing insight to multiple signal frequencies with time information. When the algorithm is integrated in sensor nodes for a distributed event detection in WSN, the energy consumed in the network is far less than when all readings are sent to the base station in a centralized network.

A pipeline monitoring system using a wireless sensing network (WSN) can be based upon multiple tiers, wherein the multiple tiers are defined or determined by their power requirements and a sensing capability factor. Collected data from the pipeline monitoring system is processed by multiple levels of a sensory node level, a local base station level, and a central control level. A first tier or level collects data for testing and analysis for a localized anomaly. A second tier or level collects data and applies power processing for real-time decision-making. A third tier or level collects data and draws inferences for system input and output. However, any of the first, second, or third tiers can be separated into multiple tier levels.

Sensing and decision algorithms are employed at all three tiers to monitor above ground or underground pipelines. Energy harvesting techniques can be employed to maintain power and to extend the life of the WSN. Objectives of the pipeline monitoring system include a self-sustainable monitoring solution that is fully automated for a given period of time. The pipeline monitoring system would be configured to detect leakages and inform a central controlling entity about the locality and intensity of the anomaly or leakage. The pipeline monitoring system should be easily deployed.

FIG. 3A illustrates a layout of an exemplary sink node 300, such as cluster head node 215 illustrated in FIG. 2B. Each sink node 300 is designed and configured to communicate with a plurality of sensor nodes in a first tier. A pipeline transportation infrastructure can be designed and configured with multiple sink nodes 300, the number of sink nodes 300 depending upon factors such as the infrastructure size, location, geographic conditions, terrain, etc. A sink node 300 has one or more servers linked to one or more data warehouses located remotely at a third tier. A sink node 300 is designed and configured to receive labeled sensory data from an associated sensory node 200 and is configured to identify a true leak 310 from a false leak. The sink node 300 is configured to determine a size of the leakage 320 that may be present. The sink node 300 is also configured with geographical information relative to its own location, as well as locations of its associated sensor nodes 200 to determine a location of the leakage 330. Alarms are present for any critical events that are determined to be within the infrastructure.

An example of data communication and routing is given hereunder for illustrative purposes only. A communication interface can be integrated with a Zigbee or DASH7 transceiver to transmit at 2.4 GHz or 400 MHz frequency range. Both protocols can allow data rates of maximum 250 kbps with intermittent or periodic signal transmissions, long battery life, and secure communications with the use of established security algorithms. With the use of a 128-bit symmetric encryption key, transmission distances can range from ten to 500 meters, depending upon line-of-sight and antenna specifics. The networking layer allows star and mesh topology creation.

The primary functions of the communication layer include data entity creation, MAC sub-layer control, and routing. The Application Support Sublayer (APS) is included as the main application component that offers control services and interfaces while working as a bridge between network layer and other components. The 433 MHz DASH7 transmission improves range further to several kilometers and provides low latency for connection with non-stationary nodes at a maximum data rate of 200 kbit/s. The use of 433 MHz provides robustness for sensor applications against penetration in concrete and water with the ability to receive signals at a larger range.

A sensor node coordinator can select either a 64-bit or a 16-bit PAN ID in addition to a channel for transmission. The ZigBee RF transmitter and receiver can be assigned a 64-bit format unique MAC address. When a node joins the network, a 16-bit network address can be used that is assigned by the coordinator. This address allows sending packets inside the network so that overhead can be reduced. Sixteen sets of channels can be used in the 2.400-2.480 GHz range with a center-to-center frequency bandwidth of 5 MHz. Different node types used inside the network are identified by a device type identifier.

A cluster transmission can be used as an application binding transmission flow between the cluster and end nodes. The maximum payload size of the packet used inside the sensor network can be 255 bytes or less, depending upon the encryption used. The power level can range from 0 to 2 mW in discrete steps.

A Received Signal Strength Indicator (RSSI) can determine the signal strength of the last RF received packet. The module allows measuring RSSI as a function of interference strength from 0 dB to −86 dB. The coordinator node can perform a channel scan prior to network operation for selection of a least interfering channel.

A pipeline monitoring system includes a linear and hierarchical infrastructure layout for WSN deployment. Sensory information from several spanned zones of the pipeline are monitored and transmitted to cluster heads over several hops, which are transmitted by long haul transmission protocol. Parameters to consider for deployment of WSN in pipeline infrastructures include coverage distance, number of hops, number of nodes, and sampling and energy harvesting rates.

In a linear pipeline monitoring topology, end nodes cannot communicate with other nodes more than one or two hops away. When a node needs to establish communication and transfer packets with another node, it can broadcast for the RSSI of other nodes in its vicinity, and a table can be formed with RSSI of the neighboring nodes. FIG. 3B illustrates an exemplary initialization algorithm that could be followed for existing routing tables built before sending out any sensor data.

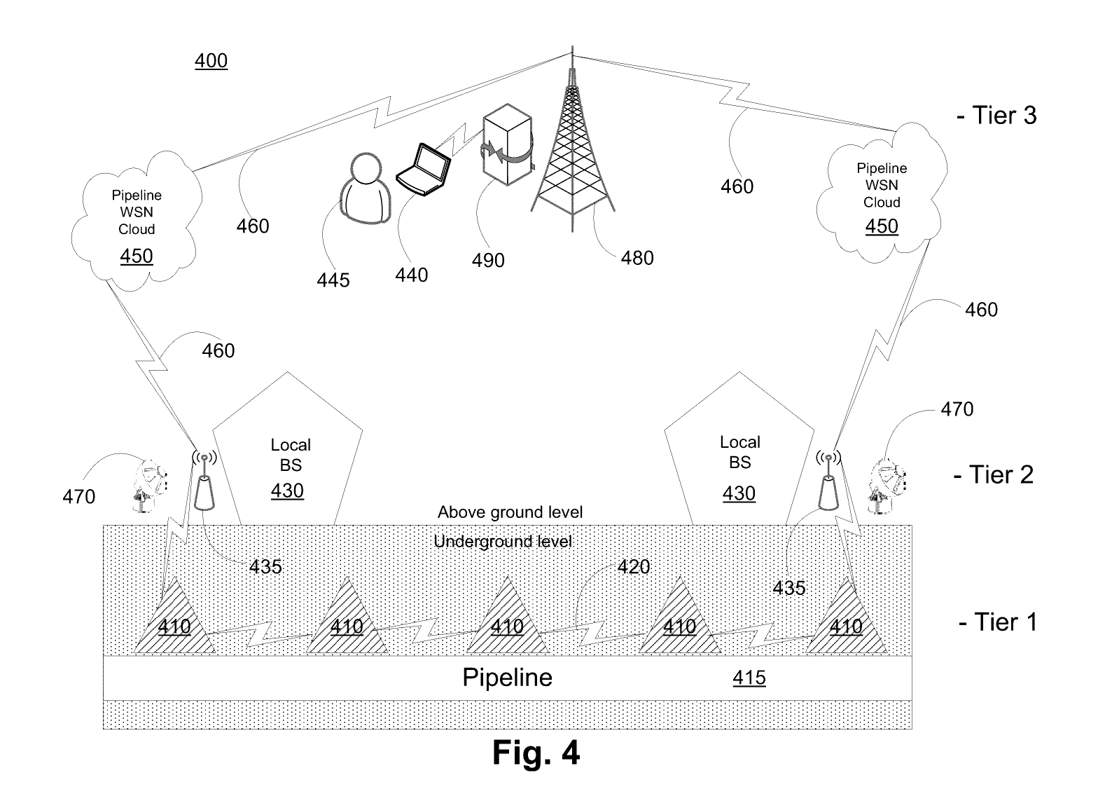

FIG. 4 illustrates an exemplary underground pipeline monitoring system 400. Multiple-tiered WSNs are employed to monitor oil, gas, water, or other liquid cargo through pipelines for any leakage, corrosion, sabotage, espionage, natural calamity, or destruction that might cause a hindrance in transportation of the fluid from one location to another location. Pipelines include, but are not limited to galvanized iron (GI) or poly vinyl chloride (PVC) pipelines that are used to carry oil, water, or other fluid or gas from one location to another.

Multiple sensor nodes collect ambient data at a first tier and send the data to a local base station at a second tier through a transmission channel. Sensors and actuators are interfaced with each node. The data from the sensors is acquired, processed, and analyzed at the second tier and transmitted to a central controller at a third tier. Sensing and decision algorithms and techniques are employed at all three tiers.

The different tier levels can be segregated based upon the power requirements and sensing capability factors of each tier. The lifetime of a pipeline monitoring system can be improved by use of energy harvesting techniques, as well as allowing nodes to utilize multiple sleep cycles over an operational duty cycle. The reliability of the system would indirectly depend upon the packet error rates, response time, packet delivery time, and power saving mechanisms, channel coding schemes, intelligent message aggregation, and resourceful node placement over the entire length of the monitored area. Power requirements of the system 400 can be met in part, using various energy harvesting techniques at all tier levels.

Even though three tiers are illustrated in FIG. 4, more or less than three tiers can be utilized and can depend upon factors, such as a size of the system, terrain, location, and payload. In addition, any of the three tiers can be divided into one or more sub-tiers. WSNs in conjunction with multimedia WSNs (WMSNs) and actuators (i.e. Wireless Sensor and Actor or Actuator Networks (WSANs)) can be employed. Ground penetrating radar, thermal cameras, and passive infrared (PIR) sensors can be used in multiple tiers. Sensor nodes can also be based on magnetic induction communication, wherein wireless communication between sensor nodes is implemented based upon a magnetic induction principal.

Sensor data acquired through the different sensors can be acquired in real time or non-real time. Sensors configured to measure or monitor temperature, humidity, vibration, light, impurity, acoustics, or other variables are interfaced to a WSN and are controlled by their respective node. The data collected from the sensor node is processed by applying various processes, such as de-noising, Fourier transform, fast-Fourier transform, Haar wavelet transform, and other processes to extract information of interest. Calculations of such processes can be performed at the local base station of the second tier or the central control unit of the third tier.

A base station (BS) includes a wireless sensor node or other computing device configured to acquire data from multiple sensor nodes linked to it. The linked architecture can include MESH or TREE configurations. The collected data from the sensor nodes is relayed or transmitted to a central controller of the third tier for further processing and analysis to determine an inference or action.

Ground penetrating radar refers to the sending of radio waves or microwaves to the ground. Waves are reflected back from a solid surface, such as a pipeline surface, thereby providing a wave pattern in which pipeline integrity information can be gleaned. Actuation refers to mechanical movement that can be triggered by a digital signal from a sensor node. The mechanical movement can incorporate motors, solenoid valves, other valves, relays, alarms, indicators, flags, and emergency services, for example.

Energy harvesting techniques can be included in a pipeline monitoring system to provide renewable sources of power. Energy harvesting techniques can include processes of conversion of any form of ambient energy, such as light, heat, vibration, or radio waves to a usable form of energy, such as electrical energy.

Embodiments described herein provide ways of detecting leakage, sabotage, espionage, theft, or other anomaly in underground or above ground fluid pipelines spread across a vast area. The sensor nodes can be deployed at regular distances. The distance between sensor nodes can be defined in accordance with various requirements, terrain, and design parameters, such as flow rate, temperature, humidity, vibration, acoustics, impurity presence, and other natural parameters. Detection data is transmitted back to a central control area, which can be a human-monitoring control point for taking action and/or disseminating instructions.

A pipeline monitoring infrastructure can include linear and hierarchical infrastructural layout for WSN deployment. Sensory information from across several zones of the pipeline can be monitored and transmitted over several hops and kilometers to cluster heads, which is transmitted by long haul transmission protocol. Parameters considered for deployment of WSN in pipeline infrastructures include coverage distance, the number of hops, the number of nodes, sampling, and the energy harvesting rates.

In a linear pipeline monitoring topology, end nodes cannot communicate with other nodes more than one or two hops away. When a node wants to establish communication and transfer packets to another node, it can send out broadcasts asking for the RSSI of other nodes in its vicinity.

With reference back to FIG. 4, system 400 includes multiple sensor nodes 410 deployed on an underground pipeline 415 to collect ambient data, such as temperature, humidity, vibration, light, impurity, acoustics, or other types of sensor node data. The multiple sensor nodes 410 communicate with each other via an underground communication wireless channel 420 between each pair of adjacent sensor nodes 410. The data can be pre-processed at a sensor node tier-1 level, or the data can be sent to a local BS 430 via a wireless access point 435 at a tier-2 level for computationally intensive processing. The data can also be relayed to a central control center 440 for intervention or monitoring by a human 445 at a tier-3 level through a transmission tower 480 and associated gateway 490, via a transmission channel 460. A pipeline WSN cloud 450 can also connect to one or more BSs 430 through a transmission channel 460.

The sensor nodes 420 can form, connect, and network in any topology deemed necessary for the required parameters, such as a Mesh, Tree, or Star Network topology. The cluster of nodes can send or relay data to an associated local BS 430 for further processing or analysis, or it can be transmitted to central control center 440. Local base stations 430 can include a microprocessor, micro-controller, single-board computer, field-programmable gate array (FPGA), or other computing device. Local base stations 430 can also include one or more ground-penetrating radar devices 470, digital signal processors, or other sensors interfaced to an associated local BS 430.

System 400 also includes a remote monitoring software system, which includes a dashboard, a GUI, and middleware. The dashboard provides real-time monitoring of oil and gas pipelines. It can provide alarm notifications for monitoring personnel. The monitoring software system can be accessible from a location over IP when the aggregator node transmits data over the network. It illustrates sensor data from different sensing nodes deployed over the pipeline infrastructure.

The exemplary remote monitoring software system includes a menu bar and a tool bar to enable performing functionalities, such as data acquisition, and data representation and maintenance. Advanced Messaging Queuing Protocol (AMQP) can be used for sending data between the field and control room or a computing device. Different queues can be allotted for sensor data and are attached to an Exchange, which adheres to the AMQP standards. Queues include, but are not limited to temperature, pressure, date, MAC, RSSI, battery, and number of hops. Data received from the middleware (AMQP) can be represented graphically and in tabular format. The parameter values from sensor nodes can be stored in respective database tables. The temperature, pressure, and battery level data can be uploaded onto the graphs or the tables. Maps can be included in the monitoring software to find the location of any sensor nodes. The sensor nodes can be represented by markers on the pipeline location of the map. A node position represents an estimate of the actual node deployed over the pipelines using node ID. When the sensor nodes are deployed sporadically, RSSI and MAC addresses can be used and displayed for each node in the software panel.

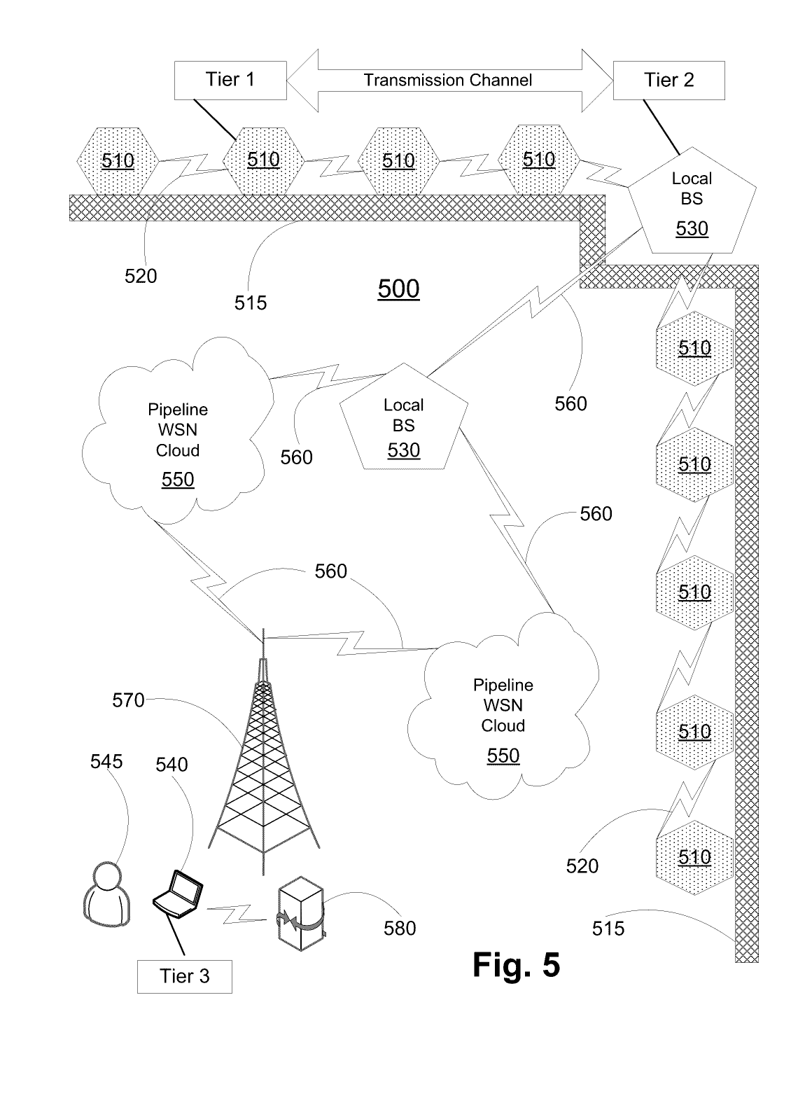

FIG. 5 illustrates an exemplary above-ground pipeline monitoring system 500. Multiple sensor nodes 510 are deployed on an above-ground pipeline 515 to collect ambient data, such as temperature, humidity, vibration, light, impurity, acoustics, or other types of sensor node data. The multiple sensor nodes 510 communicate with each other via a wireless transmission channel 520 between each pair of adjacent sensor nodes 510. The data can be pre-processed at the sensor node tier-1 level, or the data can be sent to a local BS 530 at a tier-2 level for computationally-intensive processing. A pipeline WSN cloud 550 connects to one or more BSs 530 through a transmission channel 560. The data can also be relayed to a central control center 540 for intervention or monitoring by a human 545 at a tier-3 level through a transmission tower 570 and associated gateway 580, via a transmission channel 560.

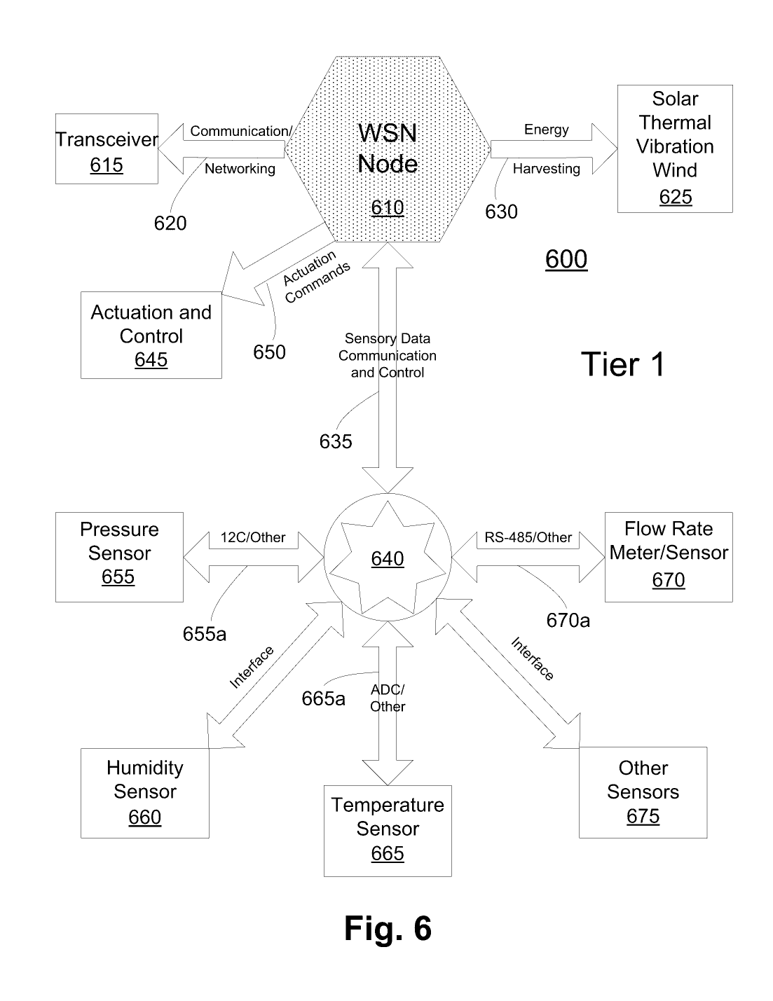

FIG. 6 illustrates an interconnection network 600 of a WSN node 610 with multiple communication channels to other devices and controlling software at a tier-1 level. WSN node 610 is integrated with a wireless or wired transceiver 615 through a communication or networking channel 620. Transceiver 615 can be supported by GSM, GPRS, EDGE, WiFi, WiMAX, DASH7, WirelessHART, Bluetooth, Zigbee, and other communication protocols. WSN node 610 can also carry an on-board GPS used in localization of sensor nodes in various terrains. WSN node 610 can be made autonomous and self-sustaining using various energy harvesting techniques 625 including, but not limited to solar, wind, thermal, vibration, radio waves, and fluid-flow energies through energy harvesting channel 630. Captured data is acquired through interfaces, such as sensory data communication and control channel 635, from a software algorithm channel 640. Channels 635 and 640 include, but are not limited to universal asynchronous receiver transmitter (UART), universal synchronous/asynchronous receiver transmitter (USART), serial-parallel interface (SPI), and inter-integrated circuit. In an embodiment, sensory data from sensory data communication and control channel 635 can be acquired on mote and pre-processed for de-noising, down-sampling, and/or up-sampling before applying further operations. In another embodiment, the pre-processed data can be used to draw inferences based upon on-board operations of the WSN node 610. Operations include, but are not limited to Fourier Transform, Fast-Fourier Transform, and Haar-Wavelett Transform.

WSN node 610 is interfaced with various actuators and controllers 645 through an actuation command channel 650. Actuators 645 include, but are not limited to motors, valves, solenoids, relays, alarms, emergency services, speakers, and various light indicators. WSN node 610 is also interfaced with various sensors, such as pressure sensors 655, humidity sensors 660, temperature sensors 665, flow rate meters and/or sensors 670, and other application-specific sensors 675 through software algorithm channel 640. Application-specific sensors 675 can include, but are not limited to proximity, radiation, bio-medical, and various gas sensors. Specific interfaces are illustrated in FIG. 6 between software algorithm channel 640 and some of the sensors. However, these are for illustrative purposes only. For example, a 12C interface 655a is illustrated between software algorithm channel 640 and pressure sensor 655. An ADC interface 665a is illustrated between software algorithm channel 640 and temperature sensor 665. An RS-485 interface 670a is illustrated between software algorithm channel 640 and flow rate meter/sensor 670. Other interfaces suited for the particular sensor as an interface with software algorithm channel 640 are contemplated by embodiments described herein. Sensory data from the sensory data communication and control channel 635 can be tested with one or more algorithms via the software algorithm channel 640, and analyzed for a localized anomaly or leakage and/or other detected parameters.

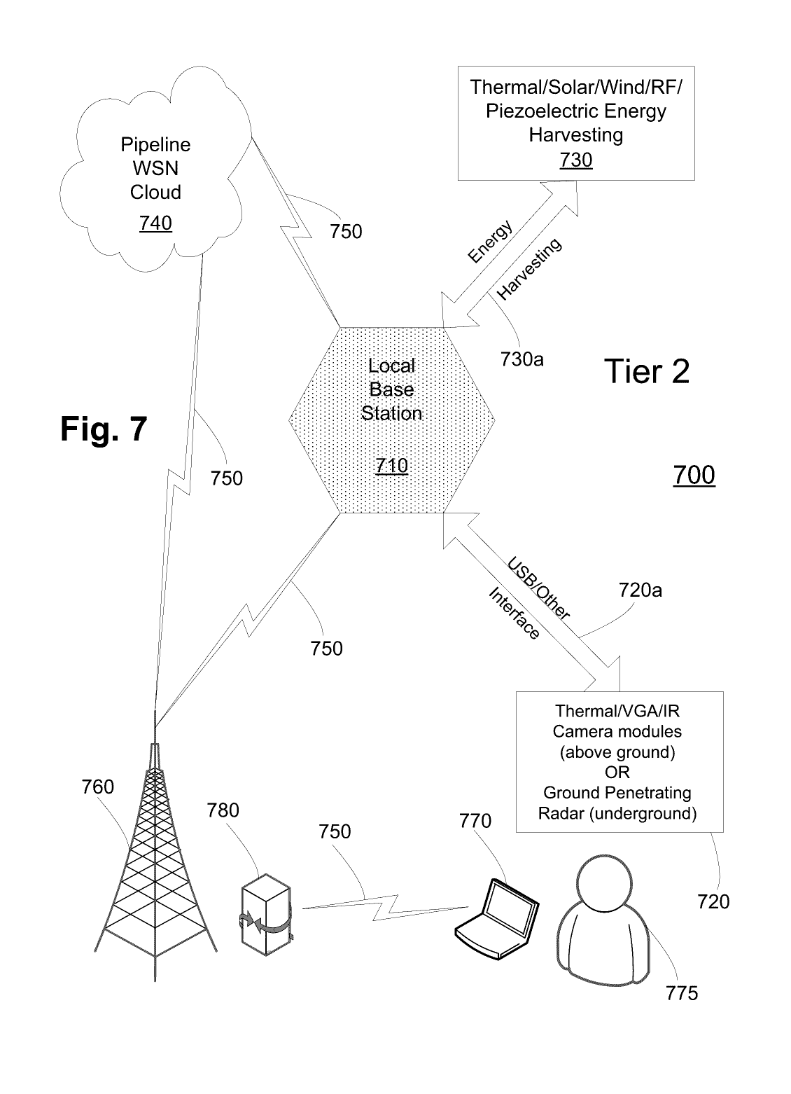

FIG. 7 is an illustration of a local base station layout 700 at a tier-2 level. Local base station 710 can be the base station for a cluster of deployed pipeline sensor nodes. In an embodiment, local base station 710 includes a computing processor, platform, or controller configured to control multimedia streams from a thermal, video graphics array (VGA), and infrared camera module 720 through a USB or other associated interface 720a. In an embodiment for an underground pipeline and sensor node array, the thermal, VGA, and infrared camera module 720 would be replaced with a ground penetrating device, such as ground-penetrating radar devices 470 illustrated in FIG. 4.

In an embodiment, local base station 710 can include thermal imagers 720, which are configured to acquire, process, and analyze data for applications ranging from leakage detection, temperature gradient analysis, espionage or sabotage activity detection, and pipeline infrastructure health monitoring. Local base station layout 700 also includes various energy harvesting technologies 730 including, but not limited to thermal, solar, wind, RF, piezoelectric, and vibration energies via an energy harvesting channel 730a to local base station 710. A pipeline WSN cloud 740 connects to local base station 710 through a first transmission channel 750, which can be subsequently transmitted to a transmission tower 760 via a second transmission channel 750. The data can also be relayed directly from local base station 710 to a central control center 770 for intervention or monitoring by a human 775 at a tier-3 level through the transmission tower 760 and associated gateway 780. Algorithms executing at local base station 710 can include artificial intelligence systems and neural networks applied for real-time decision making to avoid theft, damage, or loss to fluidic flow through pipelines within the local base station layout 700.

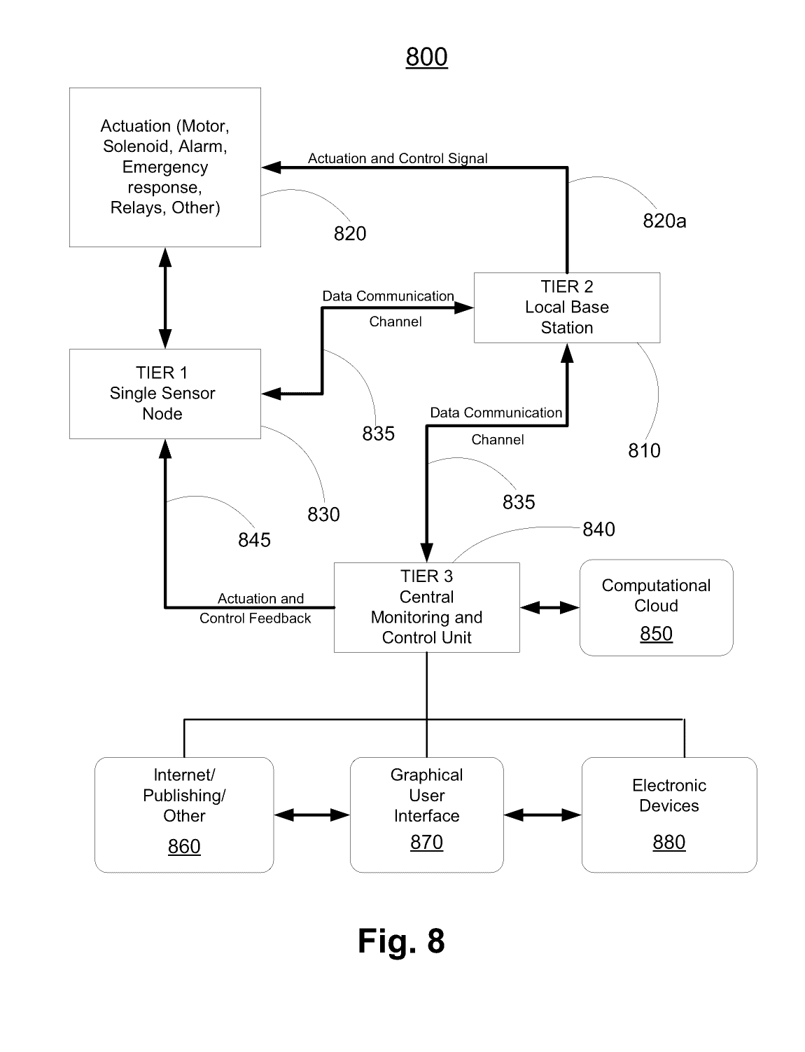

FIG. 8 illustrates an exemplary flowchart for tier-1, tier-2, and tier-3 communication within a pipeline communication network 800. Tier-1 is illustrated with just one sensor node. However, several sensor nodes are present within a cluster in the pipeline communication network 800. In addition, just one local base station is illustrated at tier-2. However, more than one local base station can be present and strategically placed in communication with a group of sensor nodes in the pipeline communication network 800.

In pipeline communication network 800, a local base station 810 at tier-2 is configured to communicate directly with actuation devices 820 via an actuation and control signal connection 820a. Actuation devices 820 include, but are not limited to motors, solenoids, alarms, emergency responses, and relays. Actuation devices 820 are interfaced with a sensor node 830. A first data communication channel 835 connects the tier-1 sensor node 830 with the tier-2 local base station 810.

A second data communication channel 835 interconnects the tier-2 local base station 810 with a tier-3 central monitoring and control unit 840. Tier-3 central monitoring and control unit 840 is configured to communicate directly with one of sensor nodes 830 within a cluster, via an actuation and control feedback connection 845. Tier-3 central monitoring and control unit 840 can also be directly connected to a computing cloud 850. Algorithms present in the computing cloud 850 are configured to analyze and process incoming data, in which inferences in terms of system input and output are drawn based upon the algorithms. In another embodiment, a data warehouse is included within the computing cloud 850 where data can be stored and retrieved.

FIG. 8 also illustrates multiple tools configured to interface with the tier-3 central monitoring and control unit 840. An Internet and publishing tool 860 provides access to the World Wide Web, as well as other networks. A graphical user interface (GUI) 870 provides a mechanism in which to interface a user with the tier-3 central monitoring and control unit 840. A vast array of electronic devices 880 provides a wired or wireless connection to the tier-3 central monitoring and control unit 840. A visualization and deployment tool is executing on one or both of the tier-3 central monitoring and control unit 840 and the computing cloud 850 to provide node position determination prior to deployment and visualization via one or more of the Internet and publishing tool 860, the GUI 870, and one or more electronic devices 880 after deployment. The visualization and deployment tool can calculate a node position from various factors including, but not limited to terrain, buildings or other infrastructures, and sensor node capabilities in terms of data rates, transceiver range, and processing power.

For a WSN, the transmission rate and antenna power can affect the distance a sensor node transmission can achieve. Since WSN applications and monitoring for infrastructure are frequently used in intense terrains and environment, wireless channel-related activities, such as fading, shadowing, and interference create a considerable loss in signal strength. To account for this, appropriate models for WSN applications can be used individually with experimentation in different terrains. The basis for such models is the inversely-proportional relationship of signal strength to distance between two sensor nodes with slight adjustments in path loss factor predicted from experimentation.

In addition to path loss, different noise forms experienced in WSN deployed in industrial environments are also important. When noise is modeled by a stochastic process, it forms a superposition of Additive White Gaussian Noise (AWGN) as a zero mean Gaussian random distributed process and impulse noise in the form of randomly distributed variable. Noise forms can be defined as:

nᵢ=ω(t)+x(t)k(t) t□[1,2, . . . ,T] (1)

where ω(t) and k(t) are zero mean Gaussian random variables and ω(t) specifically denotes AWGN, while x(t) being a binary variable can take on values [0,1]. The WSN channel can be modeled to move between good and bad states according to a two-state Markov process to describe a bursty nature of impulse noise.

If Pr_GB is represented as the probability of moving from a good state to a bad state, Pr_BG would be the probability of moving from a bad state to a good state. The two states of the WSN channel can be represented as [s(t)=G [symbol] x(t)=0] and [s(t)=B□x(t)=1]. The pdf of the stochastic noise in the good and bad states can then be defined through Gaussian variable definition as:

$$\begin{matrix}Pr [ n ( t ) \vert s ( t ) = G ] = \frac{1}{2 {πσ}^{2}} exp [ - \frac{{\vert n ( t ) \vert}^{2}}{2 {σ}^{2}} ] & ( 2 ) \\ Pr [ n ( t ) \vert s ( t ) = B ] = \frac{1}{2 π R {σ}^{2}} exp [ - \frac{{\vert n ( t ) \vert}^{2}}{2 R {σ}^{2}} ] \\ where , \\ R = \frac{Average noise power in bad state}{Average noise power in good state} & ( 3 )\end{matrix}$$

The parameter σ denotes the standard deviation of noise. For accurate detection of a bad state, R should have a value greater than 1, i.e. the noise power measured in a bad state should be greater than any noise power experienced in the good state. From the Markov channel state model, the probability of having a particular state at any time instant (t) can be written as:

Pr[S(t)]=Pr[S(t)]Πₜ₌₁^{T-1}Pr[s(t+1)|s(t)] (4)

Prᵢⱼ=P[s(t+1)=i|s(t)=j] (5)

The node separation distance and path loss derive the transmit power required to maintain a quality link in connection with the sensitivity of used antenna. A free space model can be adjusted with specifics of a path loss exponent and channel conditions to fit the WSN environment. A log-normal path loss alteration in the basic free space path loss model can be integrated in order to provide for the accuracy in loss measures for WSN in a near-ground outdoor environment. The path loss, as a log-normal equation can be written as:

ρₗₙ=ρₒ+10u log₁₀(D)+X_{σ} (6)

where ρₗₙ is a log normal path loss, ρₒ is a path loss at a reference distance, u is a path loss factor, and X_{σ} is a log normal variable with standard deviation of σ in dB. In a normal setting, ρₒ can be taken as 36 dB, u can be equal to 4, and X_{σ} has a variation of 4.70. To compare theoretical path loss formulations, experiments can be performed using Libelium Waspmotes equipped with Xbee, with Zigbee protocol-enabled transceivers equipped with 2 dBi omni-directional antennas. Tests were conducted for indoor, outdoor (freespace), and linear pipeline infrastructure of 8 inches in diameter. The pipeline infrastructure presented similar or improved RSSI for linear applications, since a variation of 2 dBm was observed when compared with normal freespace deployment. The reason for this phenomenon can be contributed to the superposition of signals at certain points, reflected from the linear pipeline structure when the nodes are placed above the metal structure. This however, would be quite different as compared to the situation where the metal pipeline structure is in the middle of two nodes causing absorption or blocking of signals.

Path loss and channel characteristics determine the transmission distance at which sensor nodes should be placed apart for maximum throughput. The transmission range has variations for an omni-directional antenna. Considering this, there can be a signal-to-noise ratio (SNR) gap for a shift from a good reliable connection to a bad connection where the packet reception may suffer losses. Therefore, we can derive several measures of inter-node receiver is present and distance placement. If the power received is proportional to ratios some relative distance at which loss is measured, we have

$${P}_{rx} ∝ {( \frac{D}{{D}_{o}} )}^{u} .$$

By conversion to an equation form,

$${P}_{rx} ( D ) = {P}_{rx} ( {D}_{o} ) + 10 u log ( \frac{D}{{D}_{o}} ) \qquad ( 7 )$$

Considering the basic relation between transmitted power and received power Pᵣₓ=Pₜₓ−ρ, we can write the fundamental relationship between capacity, bandwidth, and path loss as:

$$\frac{C}{B} = {log}_{2} ( 1 + \frac{{P}_{rx} ( D )}{{N}_{o} \times B} ) \qquad ( 8 )$$

As a result, we get the distance at which the signal can be received effectively by nodes (eqn. 9) as:

$$D = {D}_{o} \times {10}^{\frac{{P}_{rx} ( dbm ) - ρ ( {D}_{o} ) - [ 10 \times {log}_{10} [ 1000 \times {N}_{o} \times B ( {2}^{\frac{C}{B}} - 1 ) ] ]}{10 \times u}}$$

For good accuracy in measurement, the path loss exponent u can be estimated directly from the log-normal utility as

$$u = \{ \frac{{ρ}_{in} - {ρ}_{o} - {X}_{σ}}{{log}_{10} ( D )} \} \qquad ( 10 )$$

The maximum distance at which SNR is a minimum and where the signal can still be decoded presents the transmission distance, after which the signal will drastically get altered by interference. This maximum tolerable SNR region can be derived by setting the energy regeneration rate greater than or equal to the energy utilized in transmitting and receiving a packet from a branch node in the tree structure of connected nodes (n_{branch}) and (n_{branch}+1) in time T. This derives the network lifetime and signal strength as:

Power Regeneration Rate>Power transmission to upper node+Power transmission to lower branches+Power spent in reception and transmission of a relay packet

In mathematical form, we can write (eqn. 10) as

E_{R}·T≧Aᵣₐₜₑ·T·E_{elec}·u+Aᵣₐₜₑ·T·E_{elec}·u·n_{branch}+Aᵣₐₜₑ·T·(E_{elec}·b+Aₐₘₚ·b·D²)·(n_{branch}+1)

E_{R}, E_{elec}, and Eₐₘₚ are the energy regeneration rate, signal transmission, and amplification energy, respectively, while n_{branch} is the number of sensors connected to the aggregator in a tree branch. Aᵣₐₜₑ is the aggregation rate and b is the number of data bits transmitted. Aggregation rate refers to the data rate that can be received from several branch nodes over a time period T. Alternatively, it can be represented as a percentage ratio in terms of a maximum data rate (250 kbs) that can be received from a single node in one unit time. The maximum tolerable SNR distance depends upon the discrete transmission capability of the node; hence sensor i would select a discrete value Pᵢ^{j} where j, in the case of the experimental setup with Libelium Waspmotes, increases in six steps to a maximum of 1 mW. In the most simplistic linear case for equal distance placement, the distance between adjacent nodes will be adjusted as

$${D}_{i} = D = \frac{L}{{n}_{sensors}}$$

where L is the network length and nₛₑₙₛₒᵣₛ is the number of sensors deployed. For a WSN, optimal distance placement achieves a reliable link under the constraint of maximum lifetime as a function of average and initial energy. However, the nodes are placed at the minimum tolerable SNR region boundary, where any slight displacement can lead to disconnectivity, which can be addressed using a dynamic programming-based node placement algorithm. The optimal distance placement is accomplished by maximization of lifetime as a function of average and initial energy, wherein:

$${T}_{avg} = \frac{{E}_{o}}{{E}_{avg}} = \frac{{E}_{o}}{\frac{1}{n} {\sum }_{i = 1}^{n} ( {aD}_{i}^{k} {\sum }_{j = 1}^{k} {R}_{j} + b {\sum }_{j = 1}^{i - 1} {R}_{j} )} \qquad ( 11 )$$

subject to, Σᵢ₌₁ⁿDᵢ=L

By using a Lagrangian multiplier method,

$${D}_{i} = \frac{L}{{( {\sum }_{j = 1}^{i} {R}_{j} )}^{\frac{1}{u - 1}} \times {\sum }_{i = 1}^{n} {( \frac{1}{{\sum }_{j = 1}^{i} {R}_{j}} )}^{\frac{1}{u - 1}}} , 1 \leq i \leq n \qquad ( 12 )$$

Here, u is the path loss component that intrinsically relates to reliability in terms of SNR. A heuristic-based approach with the notion of reliability can also be used instead of the optimal placement, since nodes can undergo disconnection for being placed on the boundary of a transmission region. The heuristic method scales the distance as a function of the SNR reliability, achieved by reducing the distance between nodes and the number of budget nodes that can be accommodated. The node placement distance is given by:

D=Dₗₒₛₛ_{_}_{model}−(ΔD) (13)

Dₗₒₛₛ_{_}_{model} is the path loss catered-effective distance and ΔD is a scaling factor for coverage determined by dynamic programming discussed hereinafter.

The number of sensor nodes deployed for infrastructure monitoring constitutes the main resource and cost of WSN. Hence, a critical and resourceful measure can be implemented for practical deployment of nodes. From the distance calculations (eqn. 9), it follows that the number of optimal nodes required can be given as:

$${n}_{opt} \approx {argmax}_{n} {T}_{avg} = {argmax}_{n} \{ \frac{{E}_{o}}{\frac{{aL}^{u}}{{n [ {\sum }_{i = 1}^{n} {( \frac{1}{{\sum }_{j = 1}^{i} {R}_{j}} )}^{\frac{1}{u - 1}} ]}^{u - 1}} + \frac{b}{n} {\sum }_{i = 1}^{n} {\sum }_{j = 1}^{i - 1} {R}_{j}} \} \qquad ( 14 )$$

$$max \{ \frac{L}{{( \frac{1}{{\sum }_{j = 1}^{i} {R}_{j}} )}^{\frac{1}{u - 1}} \times {\sum }_{i = 1}^{n} {( \frac{1}{{\sum }_{j = 1}^{i} {R}_{j}} )}^{\frac{1}{u - 1}}} \} \leq {r}_{max}$$

subject to,

rₘₐₓ is the maximum sensing range taken to be equal to the transmission range. It follows that n×node_{cost}≦nodeₜₒₜₐₗ_{_}_{cost} i.e. the number of nodes should not exceed the node budget.

Dynamic programming should provide a tradeoff between coverage and node resources utilized against the SNR and the corresponding reliability gain. It may be necessary to find the portion of coverage in transmission range in which the node can be placed inside while meeting the budget nodes, i.e. the maximum number of nodes that can be deployed.

### Coverage Algorithm

| | |
|---|---|
| 1. | Set Coverage Length |
| | L = Total infrastructure length |
| | Node_{deployed} = Deployed Nodes |
| 2. | Define dynamic programming Population Size Pop |
| 3. | Initialize starting reliability S′ (dB) (minimum achievable SNR) |
| | corresponding to maximum transmission distance |
| 4. | Evaluate a population with decrease (ΔD) (meters) in distance and |
| | corresponding increase in (ΔS) (dB) |
| 5. | Set same ΔS (Relative change in SNR) for all deployed nodes |
| 6. | For each (ΔS, ΔD) pair from population, evaluate |
| | ${min}_{i} {ϕ}^{j} = \vert \frac{{Δs}_{i}^{j}}{{ΔD}_{i}^{j}} \vert$ |
| | where, |
| | sᵢ^{j} = Sᵢ + \|Δsᵢ^{j-1}\| and |
| | Dᵢ^{j} = Dᵢ − \|ΔDᵢ^{j-1}\| |
| 7. | If Total Covered distance < L |
| | Node_{deployed} = Node_{deployed} + 1 |
| 8. | Check constraints |
| | Node_{deployed} ≦ Nodeₜₒₜₐₗ |
| | Sᵢ ≦ Sₘₐₓ |
| | Dᵢ ≦ Dₘᵢₙ |
| 9. | If no constraint in step 8 is met, |
| | Repeat steps 4-8 |
| 10. | Else Exit |
| 11. | Report current SNR/Spectral Efficiency (db) gain |

The population size of a dynamic algorithm can also be defined, which determines the number of calculations to make at each step. The starting reliability S′ is thus set as the minimum achievable SNR. A small decrease in distance is calculated and the corresponding SNR gain is calculated. For each change in SNR and distance, the minimum of their ratios is taken in a population. The algorithm continues until a constraint in terms of maximum nodes that can be deployed, maximum SNR, or minimum node separation is met. During the algorithm sorting, whenever the infrastructure coverage becomes short, a node is deployed to suffice. At the end of the algorithm, the spectral efficiency is reported, which depicts a sufficient reliability gap.

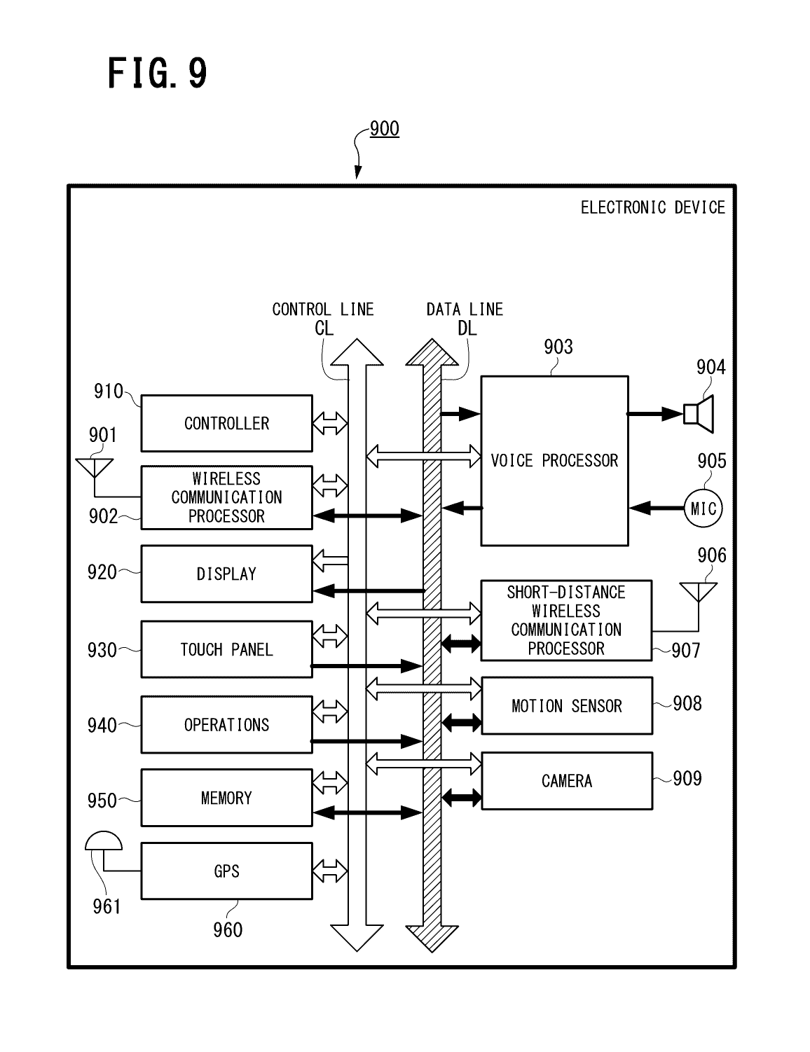

FIG. 9 is a block diagram illustrating an exemplary electronic device used in accordance with embodiments of the present disclosure. In some embodiments, electronic device 900 can be a smartphone, a laptop, a tablet, a server, an e-reader, a camera, a navigation device, etc. Electronic device 900 could be used as one or more of the devices illustrated in central control center 440, central control center 540, or central control center 770. The exemplary electronic device 900 of FIG. 9 includes a controller 910 and a wireless communication processor 902 connected to an antenna 901. A speaker 904 and a microphone 905 are connected to a voice processor 903.

The controller 910 can include one or more Central Processing Units (CPUs), and can control each element in the electronic device 900 to perform functions related to communication control, audio signal processing, control for the audio signal processing, still and moving image processing and control, and other kinds of signal processing. The controller 910 can perform these functions by executing instructions stored in a memory 950. Alternatively or in addition to the local storage of the memory 950, the functions can be executed using instructions stored on an external device accessed on a network or on a non-transitory computer readable medium.

The memory 950 includes but is not limited to Read Only Memory (ROM), Random Access Memory (RAM), or a memory array including a combination of volatile and non-volatile memory units. The memory 950 can be utilized as working memory by the controller 910 while executing the processes and algorithms of the present disclosure. Additionally, the memory 950 can be used for long-term storage, e.g., of image data and information related thereto.

The electronic device 900 includes a control line CL and data line DL as internal communication bus lines. Control data to/from the controller 910 can be transmitted through the control line CL. The data line DL can be used for transmission of voice data, display data, etc.

The antenna 901 transmits/receives electromagnetic wave signals between base stations for performing radio-based communication, such as the various forms of cellular telephone communication. The wireless communication processor 902 controls the communication performed between the electronic device 900 and other external devices via the antenna 901. For example, the wireless communication processor 902 can control communication between base stations for cellular phone communication.

The speaker 904 emits an audio signal corresponding to audio data supplied from the voice processor 903. The microphone 905 detects surrounding audio and converts the detected audio into an audio signal. The audio signal can then be output to the voice processor 903 for further processing. The voice processor 903 demodulates and/or decodes the audio data read from the memory 950 or audio data received by the wireless communication processor 902 and/or a short-distance wireless communication processor 907. Additionally, the voice processor 903 can decode audio signals obtained by the microphone 905.

The exemplary electronic device 900 can also include a display 920, a touch panel 930, an operations key 940, and a short-distance communication processor 907 connected to an antenna 906. The display 920 can be a Liquid Crystal Display (LCD), an organic electroluminescence display panel, or another display screen technology. In addition to displaying still and moving image data, the display 920 can display operational inputs, such as numbers or icons which can be used for control of the electronic device 900. The display 920 can additionally display a GUI for a user to control aspects of the electronic device 900 and/or other devices. Further, the display 920 can display characters and images received by the electronic device 900 and/or stored in the memory 950 or accessed from an external device on a network. For example, the electronic device 900 can access a network such as the Internet and display text and/or images transmitted from a Web server.

The touch panel 930 can include a physical touch panel display screen and a touch panel driver. The touch panel 930 can include one or more touch sensors for detecting an input operation on an operation surface of the touch panel display screen. The touch panel 930 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus such that the sensors included in the touch panel 930 can detect when the stylus approaches/contacts the operation surface of the touch panel display (similar to the case in which a finger is used for the touch operation).

According to aspects of the present disclosure, the touch panel 930 can be disposed adjacent to the display 920 (e.g., laminated) or can be formed integrally with the display 920. For simplicity, the present disclosure assumes the touch panel 930 is formed integrally with the display 920 and therefore, examples discussed herein can describe touch operations being performed on the surface of the display 920 rather than the touch panel 930. However, the skilled artisan will appreciate that this is not limiting.

For simplicity, the present disclosure assumes the touch panel 930 is a capacitance-type touch panel technology. However, it should be appreciated that aspects of the present disclosure can easily be applied to other touch panel types (e.g., resistance-type touch panels) with alternate structures. According to aspects of the present disclosure, the touch panel 930 can include transparent electrode touch sensors arranged in the X-Y direction on the surface of transparent sensor glass.

The touch panel driver can be included in the touch panel 930 for control processing related to the touch panel 930, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen. Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 930 and the display 920 can be surrounded by a protective casing, which can also enclose the other elements included in the electronic device 900. According to aspects of the disclosure, a position of the user's fingers on the protective casing (but not directly on the surface of the display 920) can be detected by the touch panel 930 sensors. Accordingly, the controller 910 can perform display control processing described herein based on the detected position of the user's fingers gripping the casing. For example, an element in an interface can be moved to a new location within the interface (e.g., closer to one or more of the fingers) based on the detected finger position.

Further, according to aspects of the disclosure, the controller 910 can be configured to detect which hand is holding the electronic device 900, based on the detected finger position. For example, the touch panel 930 sensors can detect a plurality of fingers on the left side of the electronic device 900 (e.g., on an edge of the display 920 or on the protective casing), and detect a single finger on the right side of the electronic device 900. In this exemplary scenario, the controller 910 can determine that the user is holding the electronic device 900 with his/her right hand because the detected grip pattern corresponds to an expected pattern when the electronic device 900 is held only with the right hand.

The operation key 940 can include one or more buttons or similar external control elements, which can generate an operation signal based on a detected input by the user. In addition to outputs from the touch panel 930, these operation signals can be supplied to the controller 910 for performing related processing and control. According to aspects of the disclosure, the processing and/or functions associated with external buttons and the like can be performed by the controller 910 in response to an input operation on the touch panel 930 display screen rather than the external button, key, etc. In this way, external buttons on the electronic device 900 can be eliminated in lieu of performing inputs via touch operations, thereby improving water-tightness.

The antenna 906 can transmit/receive electromagnetic wave signals to/from other external apparatuses, and the short-distance wireless communication processor 907 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 907.

The electronic device 900 can include a motion sensor 908. The motion sensor 908 can detect features of motion (i.e., one or more movements) of the electronic device 900. For example, the motion sensor 908 can include an accelerometer to detect acceleration, a gyroscope to detect angular velocity, a geomagnetic sensor to detect direction, a geo-location sensor to detect location, etc., or a combination thereof to detect motion of the electronic device 900. According to aspects of the disclosure, the motion sensor 908 can generate a detection signal that includes data representing the detected motion. For example, the motion sensor 908 can determine a number of distinct movements in a motion (e.g., from start of the series of movements to the stop, within a predetermined time interval, etc.), a number of physical shocks on the electronic device 900 (e.g., a jarring, hitting, etc., of the electronic device 900), a speed and/or acceleration of the motion (instantaneous and/or temporal), or other motion features. The detected motion features can be included in the generated detection signal. The detection signal can be transmitted, e.g., to the controller 910, whereby further processing can be performed based on data included in the detection signal. The motion sensor 908 can work in conjunction with a Global Positioning System (GPS) 960. The GPS 960 detects the present position of the electronic device 900. The information of the present position detected by the GPS 960 is transmitted to the controller 910. An antenna 961 is connected to the GPS 960 for receiving and transmitting signals to and from a GPS satellite.

Electronic device 900 can include a camera 909, which includes a lens and shutter for capturing photographs of the surroundings around the electronic device 900. In an embodiment, the camera 909 captures surroundings of an opposite side of the electronic device 900 from the user. The images of the captured photographs can be displayed on the display panel 920. A memory saves the captured photographs. The memory can reside within the camera 909 or it can be part of the memory 950. The camera 909 can be a separate feature attached to the electronic device 900 or it can be a built-in camera feature.

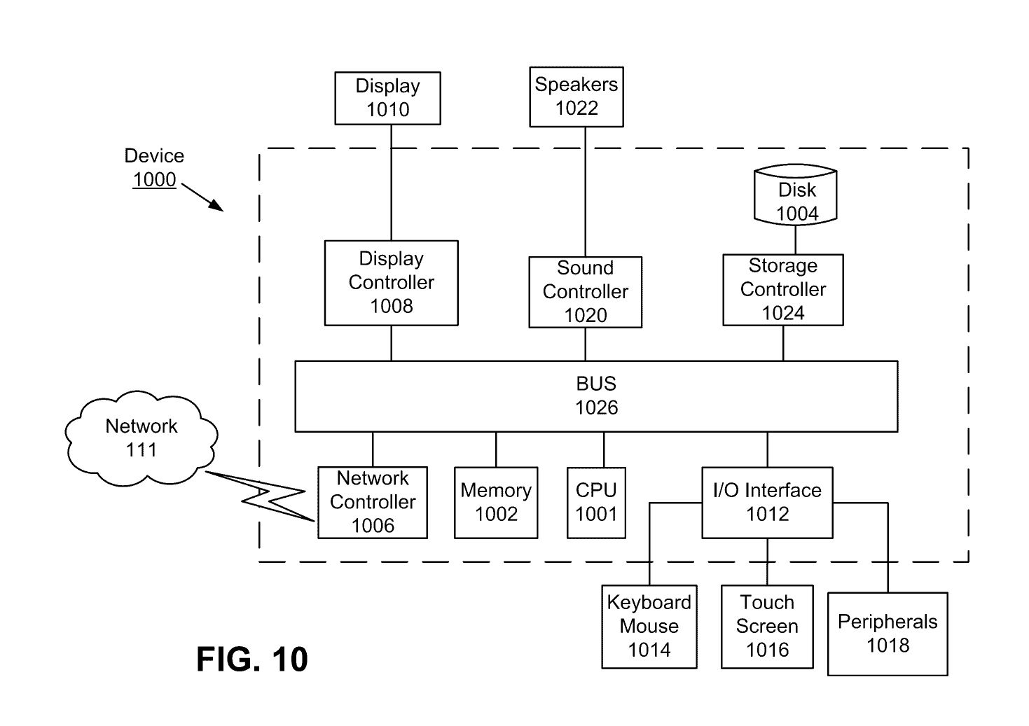

Next, a hardware description of an exemplary computing device 1000 used in accordance with some embodiments described herein is given with reference to FIG. 10. Features described above with reference to electronic device 900 of FIG. 9 can be included in the computing device 1000 described below. Computing device 1000 could be used as one or more of the devices illustrated in central control center 440, central control center 540, or central control center 770.

In FIG. 10, the computing device 1000 includes a CPU 1001 which performs the processes described above and herein after. The process data and instructions can be stored in memory 1002. These processes and instructions can also be stored on a storage medium disk 1004 such as a hard drive (HDD) or portable storage medium or can be stored remotely. Further, the claimed features are not limited by the form of the computer-readable media on which the instructions of the process are stored. For example, the instructions can be stored on CDs, DVDs, in FLASH memory, RAM, ROM, PROM, EPROM, EEPROM, hard disk or any other information processing device with which the computing device 1000 communicates, such as a server or computer.

Further, the claimed features can be provided as a utility application, background daemon, or component of an operating system, or combination thereof, executing in conjunction with CPU 1001 and an operating system such as Microsoft Windows 7, UNIX, Solaris, LINUX, Apple MAC-OS and other systems known to those skilled in the art.

The hardware elements in order to achieve the computing device 1000 can be realized by various circuitry elements, known to those skilled in the art. For example, CPU 1001 can be a Xenon or Core processor from Intel of America or an Opteron processor from AMD of America, or can be other processor types that would be recognized by one of ordinary skill in the art. Alternatively, the CPU 1001 can be implemented on an FPGA, ASIC, PLD or using discrete logic circuits, as one of ordinary skill in the art would recognize. Further, CPU 1001 can be implemented as multiple processors cooperatively working in parallel to perform the instructions of the inventive processes described above and below.

The computing device 1000 in FIG. 10 also includes a network controller 1006, such as an Intel Ethernet PRO network interface card from Intel Corporation of America, for interfacing with network 111. As can be appreciated, the network 111 can be a public network, such as the Internet, or a private network such as an LAN or WAN network, or any combination thereof and can also include PSTN or ISDN sub-networks. The network 111 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device 1000 further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. Touch screen panel 1016 includes features described above with reference to touch panel 930 of FIG. 9. General purpose I/O interface 1012 also connects to a variety of peripherals 1018 including printers and scanners, such as an OfficeJet or DeskJet from Hewlett Packard.

A sound controller 1020 is also provided in the computing device 1000, such as Sound Blaster X-Fi Titanium from Creative, to interface with speakers/microphone 1022 thereby providing sounds and/or music.

The general purpose storage controller 1024 connects the storage medium disk 1004 with communication bus 1026, which can be an ISA, EISA, VESA, PCI, or similar, for interconnecting all of the components of the computing device 1000. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

Computing device 1000 could also be used as one or more of the computing devices illustrated in sensor nodes 200, 205, 215, 300, and 610. However, the I/O interface 1012 illustrated in FIG. 10 for sensor nodes 200, 205, 215, 300, and 610 would include a wireless interface. In addition, the keyboard mouse 1014, touch screen 1016, and peripherals 1018 would not be present.

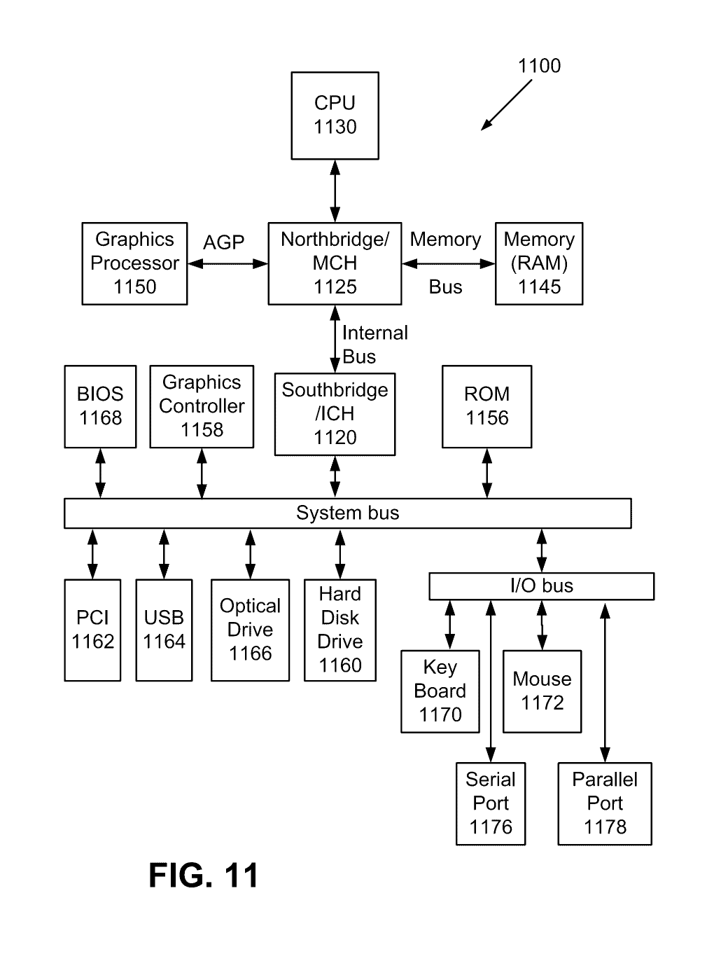

The exemplary circuit elements described in the context of the present disclosure can be replaced with other elements and structured differently than the examples provided herein. Moreover, circuitry configured to perform features described herein can be implemented in multiple circuit units (e.g., chips), or the features can be combined in circuitry on a single chipset, as shown on FIG. 11. The chipset of FIG. 11 can be implemented in conjunction with either electronic device 900 or computing device 1000 described above with reference to FIGS. 9 and 10, respectively.

FIG. 11 shows a schematic diagram of a data processing system, according to aspects of the disclosure described herein for performing menu navigation, as described above. The data processing system is an example of a computer in which code or instructions implementing the processes of the illustrative embodiments can be located.

In FIG. 11, data processing system 1100 employs an application architecture including a north bridge and memory controller application (NB/MCH) 1125 and a south bridge and input/output (I/O) controller application (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU 1130 can contain one or more processors and even can be implemented using one or more heterogeneous processor systems.

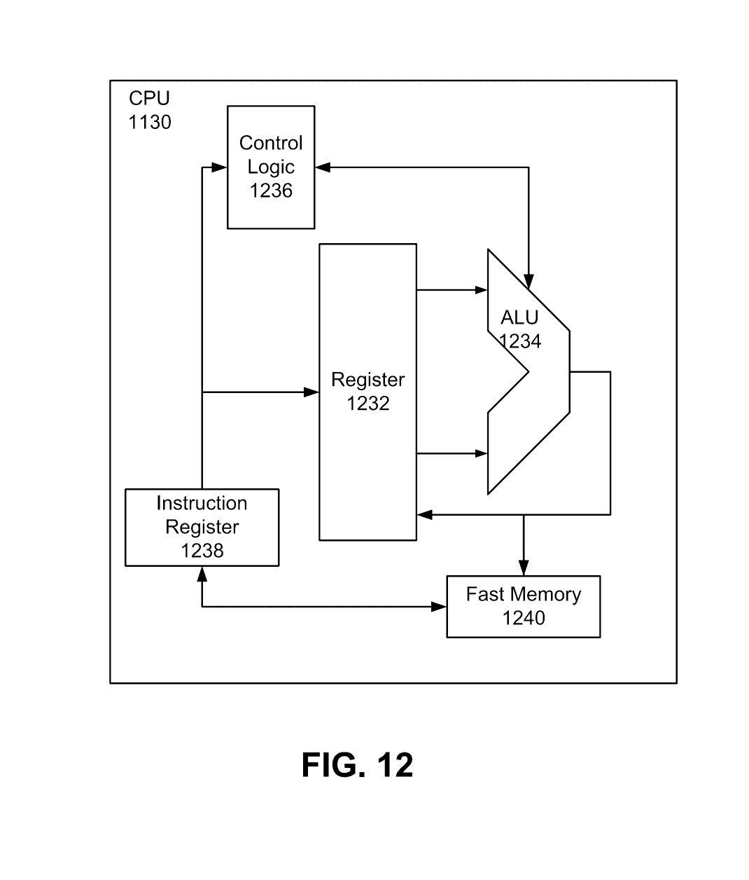

For example, FIG. 12 shows one implementation of CPU 1130. In one implementation, an instruction register 1238 retrieves instructions from a fast memory 1240. At least part of these instructions are fetched from an instruction register 1238 by a control logic 1236 and interpreted according to the instruction set architecture of the CPU 1130. Part of the instructions can also be directed to a register 1232. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using an arithmetic logic unit (ALU) 1234 that loads values from the register 1232 and performs logical and mathematical operations on the loaded values according to the instructions. The results from these operations can be fed back into the register 1232 and/or stored in a fast memory 1240. According to aspects of the disclosure, the instruction set architecture of the CPU 1130 can use a reduced instruction set computer (RISC), a complex instruction set computer (CISC), a vector processor architecture, or a very long instruction word (VLIW) architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an x86 processor by Intel or by AMD; an ARM processor; a Power architecture processor by, e.g., IBM; a SPARC architecture processor by Sun Microsystems or by Oracle; or other known CPU architectures.

Referring again to FIG. 11, the data processing system 1100 can include the SB/ICH 1120 being coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 1120 through a PCI bus 1162.

The PCI devices can include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus through the I/O bus. Other peripherals and devices can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network, such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The functions and features described herein may also be executed by various distributed components of a system. For example, one or more processors may execute these system functions, wherein the processors are distributed across multiple components communicating in a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

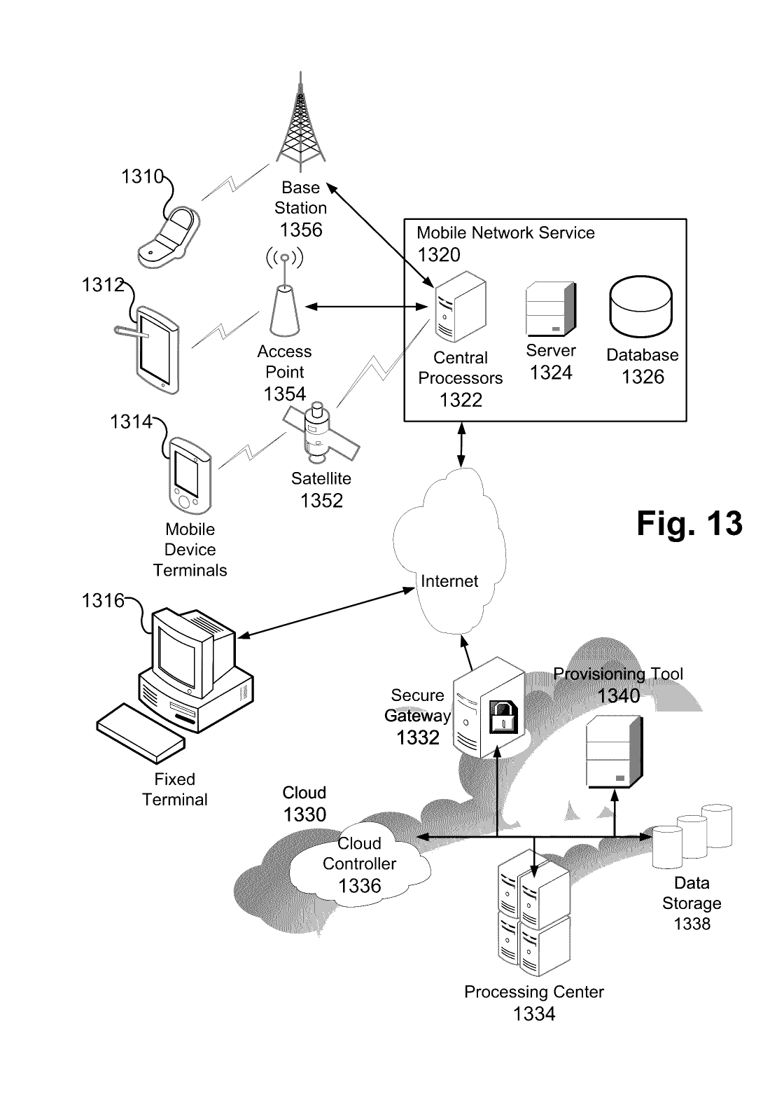

FIG. 13 illustrates an example of a cloud computing system, wherein users access the cloud through mobile device terminals or fixed terminals that are connected to the Internet. One or more of the devices illustrated in central control center 440, central control center 540, or central control center 770 could be used in the cloud computing system illustrated in FIG. 13.

The mobile device terminals can include a cell phone 1310, a tablet computer 1312, and a smartphone 1314, for example. The mobile device terminals can connect to a mobile network service 1320 through a wireless channel such as a base station 1356 (e.g., an Edge, 3G, 4G, or LTE Network), an access point 1354 (e.g., a femto cell or WiFi network), or a satellite connection 1352. In one implementation, signals from the wireless interface to the mobile device terminals (e.g., the base station 1356, the access point 1354, and the satellite connection 1352) are transmitted to a mobile network service 1320, such as an EnodeB and radio network controller, UMTS, or HSDPA/HSUPA. Mobile users' requests and information are transmitted to central processors 1322 that are connected to servers 1324 to provide mobile network services, for example. Further, mobile network operators can provide service to mobile users for authentication, authorization, and accounting based on home agent and subscribers' data stored in databases 1326, for example. The subscribers' requests are subsequently delivered to a cloud 1330 through the Internet.

A user can also access the cloud through a fixed terminal 1316, such as a desktop or laptop computer or workstation that is connected to the Internet via a wired network connection or a wireless network connection. The mobile network service 1320 can be a public or a private network such as an LAN or WAN network. The mobile network service 1320 can be wireless such as a cellular network including EDGE, 3G and 4G wireless cellular systems. The wireless mobile network service 1320 can also be Wi-Fi, Bluetooth, or any other wireless form of communication that is known.

The user's terminal, such as a mobile user terminal and a fixed user terminal, provides a mechanism to connect via the Internet to the cloud 1330 and to receive output from the cloud 1330, which is communicated and displayed at the user's terminal. In the cloud 1330, a cloud controller 1336 processes the request to provide users with the corresponding cloud services. These services are provided using the concepts of utility computing, virtualization, and service-oriented architecture.

In one implementation, the cloud 1330 is accessed via a user interface such as a secure gateway 1332. The secure gateway 1332 can for example, provide security policy enforcement points placed between cloud service consumers and cloud service providers to interject enterprise security policies as the cloud-based resources are accessed. Further, the secure gateway 1332 can consolidate multiple types of security policy enforcement, including for example, authentication, single sign-on, authorization, security token mapping, encryption, tokenization, logging, alerting, and API control. The cloud 1330 can provide to users, computational resources using a system of virtualization, wherein processing and memory requirements can be dynamically allocated and dispersed among a combination of processors and memories to create a virtual machine that is more efficient at utilizing available resources. Virtualization creates an appearance of using a single seamless computer, even though multiple computational resources and memories can be utilized according to increases or decreases in demand. In one implementation, virtualization is achieved using a provisioning tool 1340 that prepares and equips the cloud resources, such as the processing center 1334 and data storage 1338 to provide services to the users of the cloud 1330. The processing center 1334 can be a computer cluster, a data center, a main frame computer, or a server farm. In one implementation, the processing center 1.334 and data storage 1338 are collocated.

Embodiments described herein can be implemented in conjunction with one or more of the devices described above with reference to FIGS. 9-13. Embodiments are a combination of hardware and software, and circuitry by which the software is implemented.

Embodiments herein describe a sensor node leakage detection system, which includes circuitry configured to preprocess fluid flow data from leakage signals and non-leakage signals of a fluid transportation infrastructure. The circuitry is further configured to extract leakage-related features from the preprocessed fluid flow data, and select higher-ranking subset features from the extracted leakage-related features associated with leakage detection in the fluid transportation infrastructure. The circuitry is further configured to reduce a number of the selected higher-ranking subset features to fit a classification model, and train one or more classifiers using the reduced number of selected higher-ranking subset features in a supervised learning module. The circuitry is further configured to determine a final learned classifier with a maximum generalization capability from the trained one or more classifiers, and run real-time fluid flow data from the fluid transportation infrastructure. The circuitry is further configured to identify leakage signals from the running real-time fluid flow data using the final learned classifier.

The sensor node leakage detection system can also include a wireless connection to a remote sink node. The circuitry can be further configured to propagate the identified leakage signals to the remote sink node. The extracted relevant features can include features in one or more of a time domain and a transformation domain. The running real-time fluid flow data can include one or more of pressure, temperature, corrosion, stress, and thermal imaging data of the fluid transportation infrastructure.

Embodiments herein also describe a sensor node includes one or more sensors configured to measure sensory information collected from fluid flowing through a fluid transportation infrastructure. The sensor node also includes a processor configured to remove noise and unnecessary data from the collected sensory information and to extract statistical attributes associated with a leakage within the fluid transportation infrastructure. The sensor node also includes a trained classifier configured to test real-time sensor data received from the one or more sensors and processed by the processor. The sensor node also includes a transmitter configured to forward classified data from the trained classifier to a sink node within the fluid transportation infrastructure.

The sensor node can also include a receiver configured to receive sensor data from one or more neighboring sensor nodes within the fluid transportation infrastructure. The processor can be further configured to estimate a size and location of a leakage from data received from the one or more neighboring sensor nodes. The measured sensory information can include one or more of pressure, temperature, corrosion, stress, and thermal imaging data of the fluid transportation infrastructure. The trained classifier can also include circuitry configured to preprocess fluid flow data from leakage signals and non-leakage signals of the fluid transportation infrastructure, extract leakage-related features from the preprocessed fluid flow data, select higher-ranking subset features from the extracted leakage-related features associated with leakage detection in the fluid transportation infrastructure, and reduce a number of the selected prominent subset features to fit a classification model.

Embodiments herein also describe a leakage detection system includes a plurality of sensor nodes positioned along a length of a fluid transportation infrastructure. Each of the plurality of sensor nodes includes circuitry configured to measure sensory information collected from fluid flowing through the fluid transportation infrastructure, remove noise and unnecessary data from the collected sensory information and to extract statistical attributes associated with a potential leakage within the fluid transportation infrastructure, and classify the collected sensory information associated with the potential leakage. The leakage detection system also includes one or more sink nodes positioned and interfaced with an associated subset of the plurality of sensor nodes. Each of the one or more sink nodes includes circuitry configured to receive and analyze the classified collected sensory information from the associated subset of the plurality of sensor nodes, ascertain whether the potential leakage is a true leakage, determine a size and location of the true leakage, and transmit results of the determining to a central governing body of the fluid transportation infrastructure.

In the leakage detection system, the circuitry of the one or more sink nodes can be further configured to generate an alarm when the true leakage is ascertained. Determining a number of the one or more sink nodes can depend upon one or more factors of a size, location, geographical conditions, and terrain of the fluid transportation infrastructure. Determining a layout of the fluid transportation infrastructure can depend upon one or more factors of coverage distance, number of hops, and energy harvesting rates of the one or more sensor nodes and the one or more sink nodes. Each of the one or more sink nodes can include one or more servers linked to one or more data warehouses located remotely.

The leakage detection system can include a wireless sensor network. The leakage detection system can include circuitry configured for a pipeline infrastructure transporting a gas, oil, or water fluid. The leakage detection system can include circuitry configured for an underground pipeline infrastructure transporting the gas, oil, or water fluid. The leakage detection system can include circuitry configured for an above-ground pipeline infrastructure transporting the gas, oil, or water fluid. The measured sensory information can include one or more of pressure, temperature, corrosion, stress, and thermal imaging data of the fluid transportation infrastructure.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative and not limiting thereof. The disclosure, including any readily discernible variants of the teachings herein, defines in part, the scope of the foregoing claim terminology.

1. A sensor node leakage detection system, comprising:
circuitry configured to
preprocess fluid flow data from leakage signals and non-leakage signals of a fluid transportation infrastructure;
extract leakage-related features from the preprocessed fluid flow data;
select higher-ranking subset features from the extracted leakage-related features associated with leakage detection in the fluid transportation infrastructure;
reduce a number of the selected higher-ranking subset features to fit a classification model;
train one or more classifiers using the reduced number of selected higher-ranking subset features in a supervised learning module;
determine a final learned classifier with a maximum generalization capability from the trained one or more classifiers;
run real-time fluid flow data from the fluid transportation infrastructure; and
identify leakage signals from the running real-time fluid flow data using the final learned classifier.

2. The sensor node leakage detection system of claim 1, wherein the extracted leakage-related features include features in one or more of a time domain and a transformation domain.

3. The sensor node leakage detection system of claim 1, further comprising:
a wireless connection to a remote sink node.

4. The sensor node leakage detection system of claim 3, wherein the circuitry is further configured to propagate the identified leakage signals to the remote sink node.

5. The sensor node leakage detection system of claim 1, wherein the running real-time fluid flow data includes one or more of pressure, temperature, corrosion, stress, and thermal imaging data of the fluid transportation infrastructure.

6. A sensor node, comprising:
one or more sensors configured to measure sensory information collected from fluid flowing through a fluid transportation infrastructure;
a processor configured to remove noise and unnecessary data from the collected sensory information and to extract statistical attributes associated with a leakage within the fluid transportation infrastructure;
a trained classifier configured to test real-time sensor data received from the one or more sensors and processed by the processor; and
a transmitter configured to forward classified data from the trained classifier to a sink node within the fluid transportation infrastructure.

7. The sensor node of claim 6, wherein the measured sensory information includes one or more of pressure, temperature, corrosion, stress, and thermal imaging data of the fluid transportation infrastructure.

8. The sensor node of claim 6, wherein the trained classifier includes circuitry configured to:
preprocess fluid flow data from leakage signals and non-leakage signals of the fluid transportation infrastructure;
extract leakage-related features from the preprocessed fluid flow data;
select higher-ranking subset features from the extracted leakage-related features associated with leakage detection in the fluid transportation infrastructure; and
reduce a number of the selected higher-ranking subset features to fit a classification model.

9. The sensor node of claim 6, further comprising:
a receiver configured to receive sensor data from one or more neighboring sensor nodes within the fluid transportation infrastructure.

10. The sensor node of claim 9, wherein the processor is further configured to estimate a size and location of a leakage from data received from the one or more neighboring sensor nodes.

11. A leakage detection system, comprising:
a plurality of sensor nodes positioned along a length of a fluid transportation infrastructure, wherein each of the plurality of sensor nodes includes circuitry configured to
measure sensory information collected from fluid flowing through the fluid transportation infrastructure;
remove noise and unnecessary data from the collected sensory information and to extract statistical attributes associated with a potential leakage within the fluid transportation infrastructure;
classify the collected sensory information associated with the potential leakage; and
one or more sink nodes positioned and interfaced with an associated subset of the plurality of sensor nodes, wherein each of the one or more sink nodes includes circuitry configured to
receive and analyze the classified collected sensory information from the associated subset of the plurality of sensor nodes;
ascertain whether the potential leakage is a true leakage;
determine a size and location of the true leakage;
transmit results of the determining to a central governing body of the fluid transportation infrastructure.

12. The leakage detection system of claim 11, wherein the circuitry of the one or more sink nodes is further configured to generate an alarm when the true leakage is ascertained.

13. The leakage detection system of claim 11, wherein determining a number of the one or more sink nodes depends upon one or more factors of a size, location, geographical conditions, and terrain of the fluid transportation infrastructure.

14. The leakage detection system of claim 11, wherein determining a layout of the fluid transportation infrastructure depends upon one or more factors of coverage distance, number of hops, and energy harvesting rates of the one or more sensor nodes and the one or more sink nodes.

15. The leakage detection system of claim 11, wherein each of the one or more sink nodes includes one or more servers linked to one or more data warehouses located remotely.

16. The leakage detection system of claim 11, wherein the leakage detection system comprises a wireless sensor network.

17. The leakage detection system of claim 11, wherein the leakage detection system includes circuitry configured for a pipeline infrastructure transporting a gas, oil, or water fluid.

18. The leakage detection system of claim 17, wherein the leakage detection system includes circuitry configured for an underground pipeline infrastructure transporting the gas, oil, or water fluid.

19. The leakage detection system of claim 17, wherein the leakage detection system includes circuitry configured for an above-ground pipeline infrastructure transporting the gas, oil, or water fluid.

20. The leakage detection system of claim 11, wherein the measured sensory information includes one or more of pressure, temperature, corrosion, stress, and thermal imaging data of the fluid transportation infrastructure.
